(19) United States
(12) Patent Application Publication
(10) Pub. No.: US 2024/0236705 A1
(43) Pub. Date: Jul. 11, 2024

(54) WIRELESS LOCAL AREA NETWORK (WLAN) OPTIMIZATIONS UTILIZING RECONFIGURABLE INTELLIGENT SURFACE (RIS) DEVICES

(71) Applicant: Cisco Technology, Inc., San Jose, CA (US)

(72) Inventors: Jerome Henry, Pittsboro, NC (US); Robert Edgar Barton, Richmond (CA); Indermeet Singh Gandhi, San Jose, CA (US)

(21) Appl. No.: 18/150,413

(22) Filed: Jan. 5, 2023

(51) Int. Cl. H04W 16/28

(52) U.S. Cl. CPC H04W 16/28; H04W 84/12

(57) ABSTRACT

Provided herein are techniques through which a Reconfigurable Intelligent Surface (RIS) device can be controlled to facilitate various wireless local area network (WLAN) communication optimizations. In one example, a method may include providing, by a wireless access point (AP) to an RIS device that includes reflecting elements, tuning information for an RIS tuning procedure that is to be performed by the wireless AP involving a wireless client; performing the RIS tuning procedure with involving wireless client in which the RIS tuning procedure includes performing a plurality of transmissions in which the RIS device is to configure the reflecting elements according to a particular dispersion mode configuration for each transmission; and identifying a guard interval value and a particular dispersion mode configuration of the RIS device that is to be utilized for subsequent transmissions involving the wireless client.

### TECHNICAL FIELD

The present disclosure relates to wireless network equipment and services.

### BACKGROUND

Reconfigurable Intelligent Surface (RIS) devices, also known as Intelligent Reflecting Surface (IRS) devices, have recently attracted attention for use in cellular networks, such as Third Generation Partnership Project (3GPP) Fifth Generation (5G) or next Generation (nG) networks. An RIS device typically utilizes low-cost, passive phase shifting reflecting elements that allow the RIS device to reflect electromagnetic energy/waves through phase adjustments of the reflecting elements in order to direct the electromagnetic energy/waves in a particular direction.

### BRIEF DESCRIPTION OF THE DRAWINGS

FIG. 1 is a block diagram of a system that may facilitate wireless local area network (WLAN) optimizations utilizing one or more Reconfigurable Intelligent Surface (RIS) devices, according to an example embodiment.

FIGS. 2A and 2B are a message sequence diagram illustrating various operations associated with coordinated steering techniques that may be utilized to facilitate WLAN optimizations, according to an example embodiment.

FIG. 3 is a flow chart depicting a method according to an example embodiment.

FIG. 4 is a block diagram illustrating features of a system associated with reducing multipath interference in a WLAN utilizing one or more RIS devices, according to an example embodiment.

FIGS. 5A and 5B are a message sequence diagram illustrating various operations associated with associated with reducing multipath interference in a WLAN utilizing an RIS device, according to an example embodiment.

FIG. 6 is another flow chart depicting another method according to an example embodiment.

FIG. 7 is a block diagram illustrating features of a system that may be utilized to facilitate coordinated steering of an RIS device and reducing multipath interference in a WLAN utilizing another RIS device, according to an example embodiment.

FIG. 8 is a hardware block diagram of a computing device that may perform functions associated with any combination of operations discussed in connection with techniques of embodiments herein.

### DETAILED DESCRIPTION

### Overview

Embodiments disclosed herein may facilitate techniques through which a Reconfigurable Intelligent Surface (RIS) device can be controlled to facilitate various wireless local area network (WLAN) communication optimizations. In some embodiments, coordinated steering techniques can be utilized for an RIS device in order to optimize signals transmitted to/from wireless client(s) in communication with a wireless access point (AP) for a WLAN. In some embodiments, an RIS device can be controlled to dissipate Radio Frequency (RF) energy in a manner analogous to acoustic dampening, which can enable a wireless access point (AP) to utilize a minimized guard interval (GI) for transmissions with one or more wireless clients, thereby increasing or optimizing throughput provided by the wireless AP for one or more wireless clients in a WLAN.

In one embodiment, a computer-implemented method is provided that may include providing, by a AP to an RIS device that includes a plurality of configurable reflecting elements, tuning information for an RIS tuning procedure that is to be performed by the wireless AP involving a wireless client for a wireless local area network, wherein the tuning information identifies the wireless client and a plurality of dispersion mode configurations of the plurality of configurable reflecting elements of the RIS device that are to be utilized by the RIS device for the RIS tuning procedure; performing the RIS tuning procedure involving the wireless client, wherein the RIS tuning procedure comprises performing a plurality of sounding frame transmissions in which the RIS device is to configure the plurality of configurable reflecting elements according to a particular dispersion mode configuration of the plurality of dispersion mode configurations for each sounding frame transmission of the plurality of sounding frame transmissions; and identifying, based on the RIS tuning procedure, a guard interval value and a particular dispersion mode configuration of the RIS device that is to be utilized for subsequent transmissions involving the wireless client.

### Example Embodiments

Reconfigurable Intelligent Surface (RIS) devices, also known as Intelligent Reflecting Surface (IRS) devices, are considered a promising technology that can be utilized for enhancing the quality of the spectrum and/or the energy efficiency of wireless communication systems. RIS devices have primarily been studied in the context of Third Generation Partnership Project (3GPP) Fifth Generation (5G) and Next Generation (NG) Radio Access Technology (RAT)/Radio Access Network (RAN) types. However, as discussed for embodiments herein, RIS devices may also be utilized in the context of wireless local area network (WLAN) radio communication systems, such as Institute of Electrical and Electronics Engineers (IEEE) 802.11 (Wi-Fi®) radio communication systems, such as Wi-Fi 6, 6E, 7, 8 (currently being explored in 802.11 Wireless Next Generation (WNG) studies), and/or any other next generation 802.11 radio communication technology, such that future 802.11 amendments will likely strive to integrate RIS devices into WLAN (802.11/Wi-Fi) communication systems.

An RIS device is typically formed of arrays of phase-tunable unit cells (reflecting elements) provided on a standard (e.g., Flame Retardant-4 (FR4)) printed circuit board (PCB) substrate. A PIN diode (a diode having p-type semiconductor region and an n-type semiconductor region with an undoped intrinsic semiconductor region between the p-type and n-type semiconductor regions) attached to each reflecting element can switch a parasitic element to each reflecting element, thereby allowing each reflecting element to switch its resonance frequency and reflect electromagnetic energy/waves through phase adjustments of the various reflecting elements in order to direct the electromagnetic energy/waves in a particular direction.

A microcontroller or other control logic in communication with/configured for an RIS can be used to coordinate the angle at which each reflecting element will reflect a received signal. A configuration interface can also be provided for an RIS device, such as a serial connection to the board, a network connection, or the like.

Systems and methods are presented herein that leverage one or more RIS devices to facilitate various WLAN optimizations. In some embodiments, coordinated steering techniques can be utilized for an RIS device in order to optimize signals transmitted between a wireless access point (AP) and one or more wireless client(s) for a WLAN.

In some embodiments, an RIS device can be controlled to dissipate Radio Frequency (RF) energy in a manner analogous to acoustic dampening. For example, an RIS device deployed in an area near highly reflective surfaces/structures within the coverage area of a WLAN (e.g., walls, hallways, elevators, etc. that may be considered interference-producing/inducing structures) can be controlled to dampen RF reflectivity for AP transmissions caused by the surfaces/structures, thereby reducing issues typically associated with RF reflections, such as increased delay spread. Reducing delay spread caused by RF reflections by optimally controlling an RIS device to dampen or disperse reflections that would otherwise be caused by an interference-producing/inducing structure can enable an AP to lower its guard interval (GI) for transmissions, thereby facilitating increased or optimized throughput for the AP with one or more wireless client(s) for a WLAN.

In still some embodiments, multiple RIS devices deployed in a WLAN can be controlled to both optimize signal transmissions between an AP and one or more wireless clients and to dampen RF reflectivity of interference-producing/inducing structures within an RLAN in order to facilitate optimized GI selections by an AP for signal transmissions.

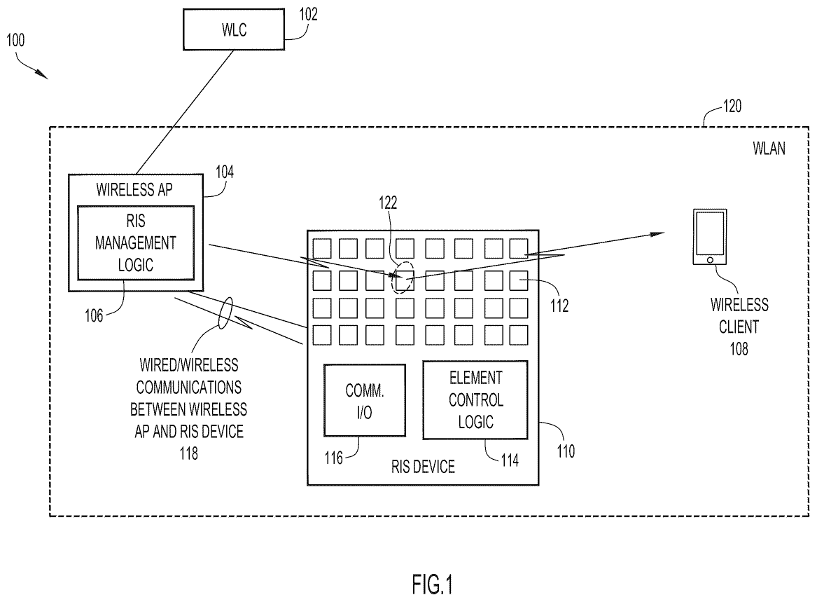

With reference to FIG. 1, FIG. 1 is a block diagram of a system 100 that may facilitate WLAN optimizations utilizing one or more RIS devices, according to an example embodiment. As illustrated in FIG. 1, system 100 may include a wireless local area network (LAN) controller (WLC) 102 and a wireless local area network (WLAN) 120 that include at least one wireless access point (AP) 104. Also shown in FIG. 1 is a wireless client 108 and at least one RIS device 110. It is to be understood that the number of wireless APs and wireless clients shown in FIG. 1 is provided for illustrative purposes only and is not meant to limit the broad scope of the present disclosure; any number of wireless APs may be configured for WLAN 120 and any number of wireless clients may be present within the WLAN 120. Further, there may be any number of RIS devices 110 deployed in the WLAN 120.

In the ensuing description, a wireless client, such as wireless client 108, may be considered a wireless device, a wireless client device, a wireless station (STA), etc. and, thus, can be referred to interchangeably as a ‘client device’, ‘wireless client’, ‘wireless STA’, ‘wireless client STA’, and ‘wireless client device’, ‘a client device configured to communicate wirelessly’, and variations thereof. Further, a wireless AP, such as wireless AP 104, may be referred to interchangeably as an ‘AP’, a ‘wireless radio’, a ‘radio’, a ‘radio node’, and variations thereof.

For the embodiment of FIG. 1. WLC 102 interfaces with wireless AP 104. Wireless AP 104 may further interface with RIS device 110 utilizing any combination of wired and/or wireless communication interfaces. WLC 102 may also interface with RIS device 110 in accordance with various embodiments herein.

As illustrated in FIG. 1, wireless AP 104 can be configured with RIS management logic 106, which can facilitate the management of RIS device 110, as discussed in further detail herein, below. Additionally, wireless AP 104 may be configured with any combination of hardware (e.g., communications units, receiver(s), transmitter(s), antenna(s) and/or antenna array(s), processor(s), memory element(s), baseband processor(s) (modems), etc.), controllers (e.g., WLAN/802.11 controllers, wired network controllers, etc.), software, logic, and/or any other elements/logic that may facilitate wireless and/or wired communications with one or more elements of system 100.

Generally, for a WLAN, such as WLAN 120, WLC 102 communicates with and controls the wireless AP 104, which serves WLAN 120 within which wireless clients, such as wireless client 108 can wireless connect to and be served by wireless AP 104. WLC 102 may also serve as a bridge to transport traffic for wireless client 108 communicated between WLAN 120/wireless AP 104 and one or more data networks (not shown), which may include one or more wide area networks (WANs), such as the Internet, and/or one or more LANs. Wireless AP 104 may provide wireless connectivity, such as IEEE 802.11 wireless connectivity (including any 802.11 variants thereof) for wireless client 108 to access one or more data networks via WLC 102. WLC 102 and wireless AP 104 may be referred to herein as a ‘wireless infrastructure’ or ‘wireless network infrastructure’.

During operation of WLAN 120, wireless client 108 can perform 802.11 association and authentication procedures via wireless AP 104 in order to wirelessly attach/connect to WLAN 120, which is under control and configuration of WLC 102 such that the wireless client 108 to establish communication sessions within system 100. Once authenticated, wireless client 108 may exchange packets with one or more networks through wireless AP 104 and WLC 102 during the communication sessions.

RIS device 110 can be considered a metasurface device with an array or matrix of engineered sub-wavelength configurable reflecting elements 112 (e.g., an M×N (row×column) array or matrix or multiple arrays/matrices), such as microstrip patches, whose reflective properties can be programmatically controlled using a tunable chip in the configurable reflecting elements 112 by changing the load impedance. RIS device 110 can be configured with element control logic 114 and one or more communication input/output (I/O) interfaces. It is to be understood that the configuration of configurable reflecting elements 112 is provided for illustrative purposes only and is not meant to limit the broad scope of embodiments herein. Configurable reflecting elements of an RIS device may be configured in any manner in accordance with embodiments herein, which may or may not be inclusive of any number of M×N array(s), array configurations having different numbers of rows/columns, non-M×N array configurations, combinations thereof, and/or the like.

The matrix or array of configurable reflecting elements 112 of RIS device 110 can be controlled using the element control logic 114. The configurable reflecting elements 112 of RIS device 110 are passive insofar as the elements reflect (without receiving and demodulating/processing) electromagnetic energy/waves by adjusting phase of the various configurable reflecting elements 112 to direct the electromagnetic energy/waves in a particular direction, such as towards a wireless client, such as wireless client 108, as generally illustrated at 122.

In accordance with embodiments herein, RIS device 110 may be capable of receiving and transmitting IEEE 802.11 communications via communication (Comm.) I/O 116 and can therefore act as an 802.11 wireless device or STA, although the medium through which communications to/from RIS device may be facilitated may include any combination of wired and/or wireless communications, as generally illustrated at 118. Accordingly, communication I/O 116 may include any combination of hardware (e.g., communications units, receiver(s), transmitter(s), antenna(s) and/or antenna array(s), processor(s), memory element(s), baseband processor(s) (modems), etc.), controllers (e.g., WLAN/802.11 controllers, wired network controllers, etc.), software, logic, and/or any other elements/logic that may facilitate wireless and/or wired communications and/or connections with RIS device 110.

Although RIS device 110 is illustrated in FIG. 1 as being (internally) configured with communication I/O 116 to facilitate wired and/or wireless communications between wireless AP 104 and RIS device 110, in some embodiments one or more elements of communication I/O 116 that may facilitate communications with wireless AP 104 may be provided external to RIS device 110 such that RIS device 110 can interface with the externally configured elements of communication I/O 116 that facilitate communications with wireless AP 104.

Similarly, although element control logic 114 is illustrated in FIG. 1 as be configured (internally) for RIS device 110, in some embodiments, element control logic 114 may be configured external to RIS device 110 and may be in communication with RIS device 110 in order to facilitate control of configurable reflecting elements 112. In some embodiments, element control logic 114 may be configured external to RIS device 110 and may control configurable reflecting elements 112 of RIS device 110, as well as configurable reflecting elements of one or more other RIS devices.

Thus, in accordance with embodiments herein, RIS device 110 can be considered attached to or otherwise interfacing with (e.g., via an 802.11 association) wireless AP 104 via a wired or wireless client that can be provided by any configuration of communication I/O 116 such that wireless AP 104 can, via RIS management logic 106, manage/control RIS device 110 to facilitate optimal steering of configurable reflecting elements 112 in order to provide improved wireless communications between wireless AP and one or more wireless clients, such as wireless client 108.

Generally, wireless client 108 may be associated with any person, user, subscriber, employee, customer, and/or the like and may be inclusive of any device that initiates a communication in the system, such as a computer, a laptop or electronic notebook, a cellular/Wi-Fi enabled telephone/smart phone, tablet, etc. and/or any other device (e.g., any Internet of Things (IoT) device or machine, etc.), component, element, or object capable of performing voice, audio, video, media, or data exchanges within system 100. Wireless clients discussed herein may include corresponding communication input/output (I/O) interface(s) each of which may include any combination of hardware (e.g., communications units, receiver(s), transmitter(s), antenna(s) and/or antenna array(s), processor(s), memory element(s), baseband processor(s) (modems), etc.), controllers (e.g., WLAN/802.11 controllers, cellular controllers, wired controllers, etc.), software, logic, and/or any other elements/logic that may facilitate wireless and/or wired communications and/or connections among one or more elements of system 100.

Conventionally, configurable reflecting elements of RIS devices can be configured statically to provide a single reflection angle or can be configured using a pre-determined sequence in time and/or space domains to provide fast sweeps through different reflection angles (e.g., for jamming purposes, etc.). In the time domain, all the configurable reflecting elements can cause the same reflection angle for an AP signal and can all be changed together to provide a new angle. In the space domain, a first (i^{th}) reconfigurable reflecting element, which may be denoted (Mᵢ, Nᵢ), may not have the same angle effect as a second (j^{th}) reconfigurable element (Mⱼ, Nⱼ), thus at a given point in time a AP signal can be reflected differently on individual elements of the array, thereby reflecting the AP signal in different directions. In accordance with embodiments herein, coordinated steering techniques are provided in order to allow wireless AP 104, via RIS management logic 106, to leverage the RIS device 110 in order to optimize transmissions to and from wireless client 108 for WLAN 120.

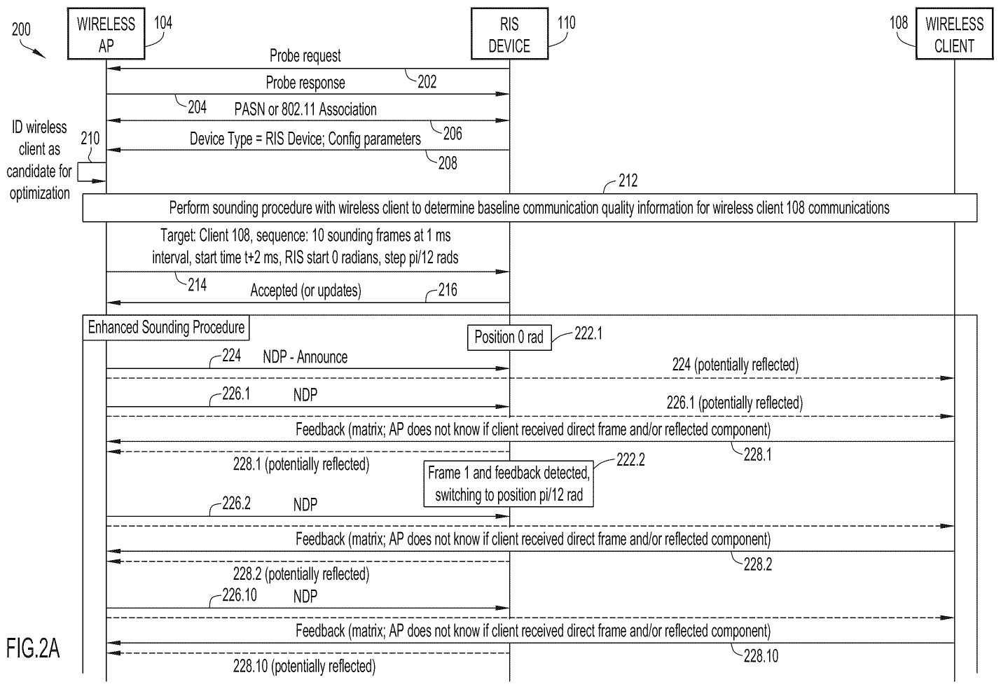

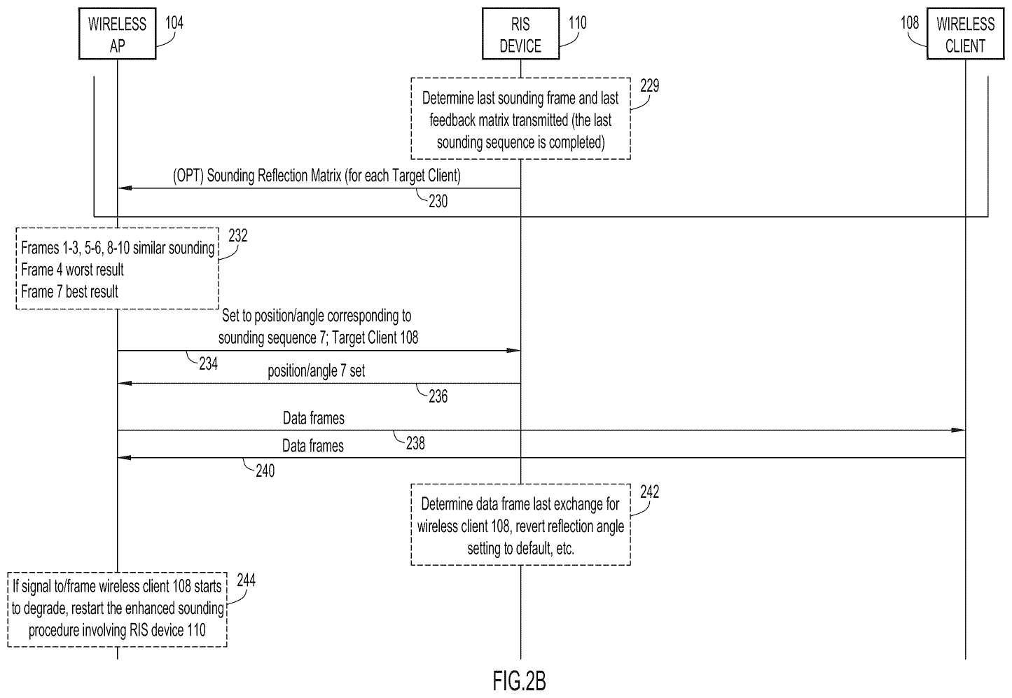

Consider an operational example discussed with reference to FIGS. 2A and 2B through which the coordinated steering techniques may be provided utilizing wireless AP 104 and RIS device 110 in order to facilitate WLAN 120 optimizations in accordance with various embodiments herein. FIGS. 2A and 2B are a message sequence diagram illustrating example operations 200 associated with coordinated steering techniques that may be utilized to facilitate WLAN 120 optimizations and includes wireless AP 104, RIS device 110, and wireless client 108.

Although not shown in FIGS. 2A and 2B, it is to be understood that wireless client 108 is attached/associated with wireless AP 104 prior to operations 200 discussed with reference to FIGS. 2A and 2B being performed.

As discussed above, RIS device 110 can be considered attached to or otherwise interfacing with (e.g., via an 802.11 association) wireless AP 104 via a wired or wireless client that can be provided any configuration of communication I/O 116 such that wireless AP 104 can, via RIS management logic 106, manage/control RIS device 110 to facilitate optimal steering of configurable reflecting elements 112 in order to provide improved wireless communications between wireless AP and one or more wireless clients, such as wireless client 108.

Thus, for embodiments in which RIS device 110 is capable of wireless communications with wireless AP 104, upon initialization of the RIS device 110, a probe request can be initiated by RIS device 110, as shown at 202, which can trigger a probe response being transmitted by wireless AP 104, as shown at 204, which may trigger additional operations, as discussed below. Other communications between wireless AP 104 and RIS device 110 could trigger further communications, such as, for example, any unassociated frame communication(s), such as an Access Network Query Protocol (ANQP) exchange, a Device Provisioning Protocol (DPP) discovery frame, or the like.

In some embodiments, RIS device 110 may perform an 802.11 association with wireless AP 104 in order to enable the wireless AP 104 to manage/control RIS device 110. However, it is to be understood that management/control of RIS device 110 by wireless AP 104 (via RIS management logic 106) is not strictly dependent on an 802.11 association between performed RIS device 110 and wireless AP 104. In some embodiments, if the RIS device 110 does not perform an 802.11 association with the wireless AP 104, management/control communications between RIS device 110 and wireless AP 104 may be performed after a Pre-Association Security Negotiation (PASN), as provided by 802.11az, such that the RIS device 110 and the wireless AP 104 may communicate via a protected (but unauthenticated) tunnel or channel through which information, such as configuration information, can be exchanged. One advantage of PASN mode communications is that while a wireless client, such as RIS device 110, may only associated with one AP (as per 802.11), there can be a PASN tunnel to each of many APs, allowing the RIS device 110 to be shared among two or more wireless APs. Thus, any combination of 802.11 association and/or PASN exchanges may be performed between RIS device 110 and wireless AP 104 in order to facilitate various operations described herein.

As illustrated at 208, the RIS device 110 can signal the nature/configuration of features provided by or supported by RIS device 110 to wireless AP 104. For example, the RIS device 110 can indicate (via any combination of flag(s), information element(s) (IE(s)), etc.), device type information indicating that the device is an RIS device and corresponding configuration parameters of the RIS device 110, which may include, but not be limited to, the matrix structure of configurable reflecting elements 112 (e.g., M rows by N columns), rotation angle granularity of the configurable reflecting elements 112 (e.g., π/12 radians granularity per angle [denoted herein ‘phi’ or symbolically as ‘ϕ’] change of the configurable reflecting elements), a current position (current phi values) of configurable reflecting elements 112, reflective capabilities of configurable reflecting elements 112 (e.g., maximum orientation, angle, or reflection), combinations thereof, and/or the like.

The information/parameters signaled to wireless AP 104 at 206 can be included in RIS discovery messages (e.g., specific IE(s) within a probe request) or in an associated or unassociated (but protected, e.g., PASN) exchange with wireless AP 104. In one instance, after PASN, the RIS device 110 could send the information/parameters (e.g., device is an RIS device, with M×N elements, each with ‘k’ angle granularity, etc.) via a new action frame.

As illustrated at 210, wireless AP 104 can identify one or a set of wireless clients/STAs, such as wireless client 108, as a candidate for improved communications via RIS device 110. Various criterion/criteria may be utilized to perform the identification at 210. For example, in some instances, the wireless AP 104 can identify one or more wireless clients having lower Received Signal Strength Indicator (RSSI) values, in relation to other wireless clients served by the wireless AP 104, as candidate(s) for communication improvements. In another example, the wireless AP can identify one or more wireless clients having an unstable channel or channel state information (CSI) indicating a poor communication channel, in relation to other wireless clients served by the wireless AP 104, as candidate(s) for communication improvements. In yet another example, the wireless AP 104 can identify one or more wireless clients having a low Modulation and Coding Scheme (MCS) value, in relation to other wireless clients served by the wireless AP 104, as candidate(s) for communication improvements. Thus, any criteria or combination of thereof may be utilized to identify one or more wireless client(s) for communication optimizations that may be provided via a given RIS device.

Upon identifying a given wireless client for communication optimizations, such as wireless client 108, wireless AP 104 can initiate a sounding procedure with wireless client 108, as shown at 212, in which the sounding procedure performed at 212 can either exclude control of (the configurable reflecting elements 112 of) RIS device 110 by wireless AP 104 or can control the RIS device 110 to change the angle of the configurable reflecting elements 112 once or twice, such that the wireless AP 104 can determine a baseline for communication quality (e.g., any combination signal strength, MCS value, CSI/channel information, etc.) between wireless AP 104 and wireless client 108. For example, the wireless AP 104 can control the RIS device 110 to changes its angle to one or two default angle(s) and, if the wireless AP 104 does not observe significant difference in the wireless client's 108 response, the wireless AP 104 can determine that the RIS is not adding constructive or destructive interference to the wireless client 108 at the default angles; thus providing a baseline for communication quality for the wireless client 108. The sounding procedure can be performed in accordance with 802.11 standards-based procedures through which one or more sounding frames including various tones can be transmitted from wireless AP 104 to wireless client 108, which triggers wireless client 108 to analyze/determine various signal/channel quality information for the tones and transmit a feedback matrix to wireless AP 104 through which wireless AP 104 can also determine various signal/channel quality information for communications with wireless client 108. In some embodiments, the operations at 212 may be optional.

Regarding the feedback matrix for the sounding procedure, consider that the wireless AP 104 sends a frame with some signal on each tone/subcarrier to the wireless client 108, which can receive the frame, possibly on multiple antennas/radio chains. Per standards-based sounding procedures, the wireless client 108 can then return to the wireless AP 104 a feedback matrix that contains, for each radio reception (Rx) chain, the angle at which each tone was received. Thus, the feedback matrix can include one row for each tone, one column for each radio Rx chain, and an angle value. The wireless client 108 can also send the wireless AP 104 a second (global rotation) matrix that can include additional values representing a global rotation value, which can indicate to the wireless AP 104 a global rotation or orientation of the antennas of the wireless client (e.g., antennas are overall oriented ‘X’ degrees left of the wireless AP), such that within that rotation/orientation reference, each tone at each Rx chain represented via the feedback matrix can be analyzed by the wireless AP 104.

Upon determining the baseline communication quality information for wireless client 108 that excludes control of RIS device 110, the wireless AP 104 can initiate an enhanced sounding procedure through which different reflection angles can be configured for configurable reflecting elements 112 of RIS device 110 through a plurality of sounding sequences in order for wireless AP 104 to determine whether any communication quality improvements can be provided by RIS device 110 for communications between wireless AP 104 and wireless client 108.

As shown at 214, wireless AP 104 can transmit a sounding warning frame to the RIS device 110 that includes sounding parameters/information for the enhanced sounding procedure that is to be performed by the wireless AP 104. In various embodiments the sounding parameters/information included in the sounding warning frame may include, but not be limited to: sounding sequence parameters/information, such as a number of sounding frames to be transmitted by the wireless AP; an intended interval between the sounding frame transmissions; a desired rotation angle factor or step and direction (represented by a positive (e.g., counterclockwise) or negative (e.g., clockwise) angle value, e.g., π/12 radians or −π/12 radians) that is to be adjusted for the configurable reflecting elements 112 for each successive sounding frame transmission; sounding type information (e.g., training frames that return a matrix (for High Throughput (HT), Very High Throughput (VHT), or Television VHT (TVHT), which can be expressed as designed for calibration or channel quality assessment and can be associated with different structures (e.g., number of tones or length of the sounding frame, header structure, etc.)); timing or index information, such as a start time for the enhanced sounding procedure (e.g., an absolute time or time offset relative to the time at which the sounding warning frame is received by the RIS device 110); target wireless client(s) to be involved in the enhanced sounding procedure (e.g., each identified via a Media Access Control (MAC) address, Internet Protocol (IP) address, or any other non-MAC or non-IP address identifiers (permanent/stable or non-permanent/non-stable (e.g., may be rotated/changed), that may be used to identify target client(s)); a likely preferred angle position or a starting angle position for the configurable reflecting elements 112; combinations thereof; and/or the like.

For example, as shown at 214, wireless AP 104 can signal to RIS device 110, at a time ‘t’, that wireless client 108 is to be involved in the enhanced sounding procedure, that the procedure is to involve 10 sounding frames transmitted at 1 millisecond (ms) intervals, that the procedure is to begin at a start time of ‘t’+2 ms, that the RIS device 110 is to start with the angles of the configurable reflecting elements 112 set to 0 radians and is to increase the angle of the configurable reflecting elements 112 by π/12 radians per sounding frame transmission. It is to be understood that other angle steps can be used.

As shown at 216, RIS device 110 can respond to wireless AP 104 and indicate that RIS device 110 accepts the sounding parameters received from the wireless AP 104 or can indicate updates to the sounding parameters. In some instances, RIS device 110 may indicate a different sounding sequence parameters than those sent from wireless AP 104. For example, in some embodiments, RIS device 110 may be statically configured (e.g., by a manufacturer) to only rotate configurable reflecting elements 112 by a fixed angle, such as π/16 radians, at each iteration. RIS device 110 could signal such information to wireless AP 104 at 216. Other variations for sounding parameter updates can be envisioned.

Thereafter, the enhanced sounding procedure can be performed, as shown at 220, in which RIS device 110, via element control logic 114, sets the reflection angle of the configurable reflecting elements 112 to the starting angle position (0 radians, in this example), as shown at 221.1.

As shown at 224, wireless AP 104 transmits a Null Data Packet (NDP) announcement (NDP-A) frame, per standards-based procedures, to signal initiation of the enhanced sounding procedure. The NDP-A frame transmission at 224 can potentially be reflected by the RIS device 110 toward wireless client 108 depending on whether the current position of the configurable reflecting elements 112 are directing the transmission toward wireless client 108 or the NDP-A frame can be received directly by the wireless client 108 if the current position of the configurable reflecting elements 112 are not directing the transmission toward wireless client 108.

Thereafter, a series of sounding sequences may be performed in which, for a first sounding sequence of the ten sounding sequences to be performed (e.g., ten sounding frames were indicated by the wireless AP 104 as being involved in the enhanced sounding procedure), the first sounding frame for the enhanced sounding procedure is transmitted by wireless AP 104 via an NDP frame transmission (including sounding tones), as shown at 226.1. The NDP frame transmission at 226.1 can potentially be reflected by the RIS device 110 toward wireless client 108 depending on whether the current position of the configurable reflecting elements 112 are directing the transmission toward wireless client 108 or the NDP frame can be received directly by the wireless client 108 if the current position of the configurable reflecting elements 112 are not directing the transmission toward wireless client 108. The NDP frame transmitted at 226.1 includes identifying information (e.g., MAC address) for the wireless client 108 such that RIS device 110, via communications I/O 116 (which is configured to operate in accordance with 802.11 standards, as discussed herein) can identify that the first sounding frame from wireless AP 104 has been transmitted.

It is noted for the enhanced sounding procedure, the wireless AP 104 does not know if the wireless client 108 receives the sounding frames directly from the wireless AP 104 or as reflected by the RIS device 110.

At 228.1. per standards-based sounding operations, the wireless client 108 transmits a corresponding feedback matrix calculated for the sounding tones received in the NDP transmission (direct or reflected). Similar to transmissions from wireless AP 104 toward wireless client 108, the feedback matrix transmitted by wireless client 108 can potentially be reflected back to the wireless AP 104 via RIS device or can be received directly from the wireless client 108.

The feedback matrix transmitted at 228.1 includes identifying information (e.g., MAC address) for the wireless client 108 such that RIS device 110 can identify that both the first sounding frame from wireless AP 104 has been transmitted and that the wireless client 108 has transmitted its first feedback matrix to the wireless AP 104 in response to the first sounding frame. The exchange of a sounding frame transmission being sent from the wireless AP 104 to a wireless client and the wireless client transmitting a feedback matrix to the wireless AP 104 can represent the completion of a given sounding sequence or cycle.

In at least one embodiment, upon detecting a sounding exchange involving both a sounding frame transmission and a feedback matrix transmission being performed, which indicates that a particular sounding sequence has been completed, the RIS device 110 can (if multiple sounding frames are to be sent for the enhanced sounding procedure) update/rotate the reflection angle of the configurable reflecting elements 112 by a configurable rotation angle factor or step and direction (e.g., represented by an angle value), as shown at 222.2, which could be the angle factor and direction as expressed by the wireless AP 104 via the sounding warning frame transmitted at 214 or could be a statically configured fixed angle for the RIS device 110.

However, updating/rotating the angle of configurable reflecting elements 112 by the RIS device 110 is not dependent on the RIS device 110 detecting that both a sounding frame transmission and a feedback matrix transmission have been performed. For example, if the RIS device 110 knows the intended interval between sounding frame transmissions and knows the start time for the enhanced sounding procedure, the RIS device 110 could automatically update/rotate configurable reflecting elements 112 based on the interval (e.g., every 1 ms) such that the RIS device 110 could determine that a sounding sequence or cycle is expected to be completed at every interval.

It is noted that the operations illustrated for FIGS. 2A and 2B are shown for only one wireless client, wireless client 108. However, it is to be understood that for sounding involving multiple wireless clients, the wireless AP 104 could transmit multiple sounding frames at 228.1. one sounding frame transmission for each wireless client that is intended for the enhanced sounding procedure, and each client could transmit a corresponding feedback matrix in response to their corresponding sounding frame transmission. In such instances, determining the end of a particular sounding sequence or cycle could include determining that each sounding frame transmission and each feedback matrix transmission for each wireless client had been completed for the particular sounding sequence or cycle.

The enhanced sounding procedure operations can be continued in a similar manner, as shown 226.2 and 228.2 thru 226.10 and 228.10, e.g., for ten sounding sequences or cycles, until all sounding frame sequences or cycles that the AP announced in 214 have been performed (e.g., all sounding frames have been transmitted by wireless AP 104 and all feedback matrices have been received by wireless AP 104).

Continuing to FIG. 2B, as shown at 229, the RIS device 110 can determine when the last sounding frame has been transmitted for the enhanced sounding procedure (based on the sounding sequence parameters/information received at 214 indicating the number of sounding frames) and the last feedback matrix has been transmitted by the wireless client 108, thereby determining that the last sounding sequence or cycle has been completed. In at least one embodiment, upon determining that the last sounding sequence or cycle has been completed, the RIS device 110 can optionally transmit a sounding reflection matrix to the wireless AP 104, as shown at 230, that includes each NDP frame sequence index and the angle at which the configurable reflecting elements 112 of the RIS device 110 were set for each sounding sequence or cycle (e.g., index 1, 0; index 2, π/12; index 3, 2π/12 or π/6; index 4, 3π/12 or π/4, etc.). In some embodiments, the RIS device 110 could transmit a sounding reflection matrix to the wireless AP at the end of each sounding sequence or cycle. In some embodiments, other parameters/parameters information could be included in a sounding reflection matrix, such as identifying information for feedback matrix responders (e.g., the target wireless client(s)) that were detected by the RIS device 110.

However, as noted above, transmission of one or more sounding reflection matrices by RIS device 110 is an optional feature. As discussed at 214, since the wireless AP 104 can transmit sounding sequence parameters/information to the RIS device 110, information included in one or more sounding reflection matrices may not be needed by the wireless AP 104.

Continuing to 232, the wireless AP 104 can analyze/compare each feedback matrix received for each sounding sequence for wireless client 108 in order to determine a particular sounding sequence or cycle and corresponding reflection angle of the configurable reflecting elements 112 of the RIS device 110 that yielded the highest signal/channel quality (e.g., highest signal gain) compared to other sounding sequences/cycles, for example, the matrix that displayed the largest conformity with the signal sent by the wireless AP 104 for a given sounding cycle.

For example, consider that the wireless AP 104 sends each tone at a specific power and angle (relative to a neighboring tone). In an ideal scenario, the wireless client 108 should receive them at the same relative angle (except that multipath interference can impact the reception). The second matrix (the global rotation matrix) received by the wireless AP 104 can be multiplied with the first (feedback) matrix received by the wireless AP 104, in order to determine an indication of the amplitude at which the tones were received. In one example, the feedback matrix with the highest multiplied result can indicate the highest gain to the wireless client 108 for a corresponding sounding cycle, such that the wireless AP 104 can determine that the wireless client 108 may receive the strongest signal at the position of the configurable reflecting elements 112 of the RIS device 110 for the corresponding cycle, which represents the best likely RIS position for the wireless client.

In one embodiment, the comparison at 232 can involve a comparison to the results received for the baseline sounding procedure performed with the wireless client 108 at 212.

In this example, consider that wireless AP 104 determines at 232 that sounding frames (sequences/cycles) 1, 2, 3, 5, 6, 8, 9, and 10 yielded similar sounding results for wireless client 108, that sounding frame 4 yielded the worst result (e.g., decreased signal/channel quality compared to the baseline results), and that sounding frame 7 yielded the best result. As such, the wireless AP 104 can identify that the optimal reflection angle setting for the configurable reflecting elements 112 of RIS device would correspond to the reflection angle setting for sounding sequence index number 7.

As shown at 234, when the wireless AP 104 intends to initiate a data exchange with the wireless client 108 (e.g., either a downlink (DL) stream transmission (data frame(s) that the client wants to send to the AP) or a trigger for an uplink (UL) (or upstream) scheduled transmission (frame(s) sent from the AP to the client)), the wireless AP 104 can precede its transmission with a frame transmission to the RIS device 110 (e.g., a management frame of type ‘action (an action frame) or a data frame with the configuration included as the payload), or potentially a wire-based communication to the RIS device 110 if interfacing with the RIS device via a wired connection, that indicates the number of frames expected to be exchanged (uplink and downlink) with the wireless client 108 (e.g., [target: wireless client 108 (potentially, target MAC of the client); number of frames]) and the preferred reflection angle setting for the configurable reflecting elements 112 of RIS device 110. In one embodiment, a preferred reflection angle setting could identify a specific reflection angle setting (e.g., 6π/12 or π/2). However, in another embodiment, a preferred reflection angle setting could simply identify a sequence index value (e.g., index=7) or other sounding timing information such that the RIS device 110 could identify the corresponding reflection angle setting that was used for a particular sounding sequence or cycle (e.g., sequence index 7). The RIS device can confirm the reflection angle setting to the wireless AP, as shown at 236.

Thereafter, as shown at 238 and 240, data frames can be exchanged between the wireless AP 104 and wireless client 108 in which the data frame transmissions would be reflected via configurable reflecting elements 112 of RIS device 110. In at least one embodiment, as shown at 242, upon determining the last data frame exchange between wireless AP 104 and wireless client 108, the RIS device 110 can revert the reflection angle setting of the configurable reflecting elements 112 to a default value, or some other value that could be configured for the RIS device 110.

Further, as shown at 244, the wireless AP 104 can monitor the movement and signal/channel quality for communications involving wireless client 108 and, if the signal/channel quality starts to degrade, the wireless AP 104 can restart an enhanced sounding procedure (e.g., as shown at 220) involving RIS device 110 to determine whether a reflection angle update may be needed for the configurable reflecting elements 112.

In some embodiments, assuming historical reflecting angle setting information for a given coverage area covered by wireless AP 104 is available (e.g., stored by wireless AP 104 and/or WLC 102), wireless AP 104 could track the movement of wireless client 108 and automatically update reflection angle settings for the configurable reflecting elements 112 of RIS device 110 as the wireless client 108 moves throughout the coverage area for wireless AP in order to angle the reflective energy transmitted by wireless AP 104 toward wireless client 108, ensuring the wireless client is within RF reach.

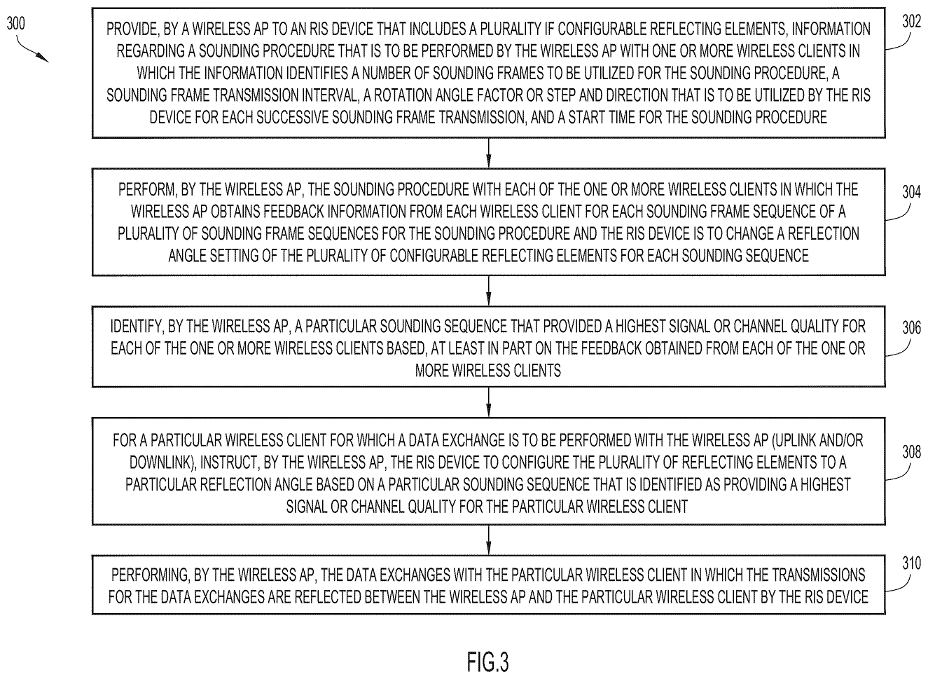

Referring to FIG. 3, FIG. 3 is a flow chart depicting a method 300 according to an example embodiment. In at least one embodiment, method 300 may be associated with techniques that may be utilized to facilitate coordinated steering of one or more RIS devices, which may be performed by at least in part by a wireless AP, such as wireless AP 104, and/or by an RIS device, such as RIS device 110, as illustrated in FIG. 1.

At 302, the method may include providing, by a wireless AP to an RIS device that includes a plurality of configurable reflecting elements, information regarding a sounding procedure that is to be performed by the wireless AP with one or more wireless clients in which the information identifies a number of sounding frames to be utilized for the sounding procedure, a sounding frame transmission interval (e.g., every 1 ms), a rotation angle factor or step and direction (e.g., positive or negative) that is to be utilized by the RIS device for each successive sounding frame transmission, and a start time for the sounding procedure. In one embodiment, the information may further identify one or more target wireless client(s) that are to be involved in the sounding procedure (e.g., MAC address(es), etc.). In one embodiment, the information can be provided to the RIS device via a sounding warning frame transmitted by the wireless AP.

In some embodiments, prior to the operations at 302, the method may include obtaining, by the wireless AP from the RIS device, configuration parameters or information identifying features provided and/or supported by the RIS device, such device type information indicating that the device is an RIS device, a matrix structure or other structure of configurable reflecting elements (e.g., M rows by N columns or other configuration) of the RIS device, the rotation angle granularity (e.g., resolution) of the configurable reflecting elements, current position (current phi values) of the configurable reflecting elements, reflective capabilities of the configurable reflecting elements (e.g., maximum orientation, angle, or reflection), and/or the like. In some embodiments, the configuration parameters/information can be sent by the RIS device after the RIS device performs an 802.11 association with the wireless AP. In some embodiments, the configuration parameters/information can be sent to the wireless AP without the RIS device performing an 802.11 association with the wireless AP. For example, in some embodiments, the RIS device can send the configuration parameters/information via PASN communications with the wireless AP.

At 304, the method may include performing, by the wireless AP, the sounding procedure with each of the one or more wireless clients in which the wireless AP obtains feedback information from each wireless client for each of a sounding sequence (or cycle) of a plurality of sounding sequences (or cycles) for the sounding procedure and the RIS device is to change a reflection angle setting of the plurality of configurable reflecting elements for each sounding sequence.

In at least one embodiment, the method may include the wireless AP obtaining a sounding reflection matrix from the RIS device either for each sounding sequence or at the end of the sounding procedure in which the/each sounding reflection matrix identifies each reflection angle configuration for the plurality of configurable reflecting elements, and potentially identifies a sounding sequence index value. In one embodiment, the RIS device may determine that a particular sounding sequence has completed by detecting both sounding frame transmission(s) from the wireless AP and corresponding feedback matrix transmission from each of the one or wireless clients for a particular sounding sequence or cycle. In one embodiment, the RIS device may determine that a particular sounding sequence has completed based on the sounding frame transmission interval information sent to the RIS device from the wireless AP.

At 306, the method may include identifying, by the wireless AP, a particular sounding sequence (or cycle) that provided a highest signal or channel quality for each of the one or more wireless clients based, at least in part on the feedback obtained from each wireless client. In some embodiments, the determination at 306 may be based additionally on baseline signal or channel quality information obtained by the wireless AP through a baseline sounding procedure that excludes use of the RIS device during the baseline sounding procedure. In various embodiments, a highest signal or channel quality can be determined based on determining a feedback matrix for a corresponding sounding sequence or cycle that is more conformant to the sounding frame transmitted for that corresponding sequence/cycle and/or with the highest amplitude compared to other feedback matrixes for other sounding sequences/cycles.

At 308, the method may include, for a particular wireless client for which a data exchange is to be performed with the wireless AP, instructing, by the wireless AP, the RIS device to configure the plurality of configurable reflecting elements to a particular reflection angle based on the particular sounding sequence that is identified as providing the highest signal or channel quality for the particular wireless client. In at least one embodiment, the instructing may include the wireless AP identifying the particular wireless client to the RIS device (e.g., providing the wireless client's MAC address, etc.), identifying the number of data exchanges that are to be performed between the wireless AP and with particular wireless client, and potentially identifying the type of exchanges to be performed (e.g., uplink and/or downlink).

At 310, the method may include performing, by the wireless AP, the data exchanges with the particular wireless client in which the transmissions for the data exchanges are reflected between the wireless AP and the particular wireless client by the RIS device.

Accordingly, embodiments herein may provide coordinated steering techniques that can be utilized for an RIS device in order to optimize signals transmitted between a wireless AP and one or more wireless client(s) in a WLAN.

Beyond controlling an RIS device to facilitate optimized communications between a wireless AP and one or more wireless clients in a WLAN, in some RF environments, multipath interference can negatively impact wireless (e.g., Wi-Fi) performance. For example, reflections (e.g., electromagnetic energy/waves) of RF signals from certain types of surfaces (e.g., metallic surfaces) can cause the delay spread in a dense environment, which can result in a wireless AP having to set (unwanted) longer Guard Intervals (GIs) for transmissions to wireless clients, which can reduce performance for the whole WLAN.

In a WLAN environment, delay spread can generally be defined as the interval between a transmitted signal and its measurable and significant reflected copy. General delay spread values are commonly defined for typical environments and power levels (e.g., an indoor space with plaster walls, a transmitter with an equivalent or effective isotropic radiated power (EIRP) of 23 dBm, etc.) to represent delays beyond which the reflected echoes are unlikely to present significant destructive effects on a receiver. The delay spread can also be measured directly by the wireless AP receiver for uplink traffic transmitted by a given wireless client. Per current WLAN implementations, delay spread cannot be measured at the wireless client level and reported back to a wireless AP. Generally, a WLAN environment is expected to be symmetrical (e.g., the farthest destructive obstacle is expected to be about the same distance from the wireless AP and the wireless client, such that the delay spread for uplink traffic transmitted by the client is expected to be the same as the delay spread for downlink transmissions by the wireless AP.

For wireless transmissions provided by a wireless AP, the Guard Interval (GI) represents a period of time that the wireless AP is to wait between transmissions, based on the measured delay spread for an environment, to ensure that the subsequent transmission of a symbol (following a prior symbol transmission) does not interfere with a prior reflected signal that has not yet been heard by the wireless client. Delay spread operates/is determined at the symbol level. For example, for wireless AP transmissions, each tone contains a symbol, which is a modulated sequence that carries the representation of a series of 0 s and 1 s (data), then a small silence (the GI, which may include some white noise), then the next symbol transmission is performed by the wireless AP. Typically, the symbol lasts for 3.2 microseconds (us) (but it can be longer depending on the modulation and environment), and the GI is provided to allow that any reflection would hit back at the wireless AP a point in time where nothing significant (just white noise) is transmitted by the wireless AP. Depending on how far the obstacles are, the time for the signal to hit the farthest obstacle and be reflected back to impact the system (the delay spread) may be small or large. Thus, the wireless AP can set the GI value for it to be large enough that there is a minimal chance that the reflection would hit back at the time when the next symbol is being transmitted by the wireless AP. However, as discussed below, it is advantageous for the wireless AP to utilize a lower GI setting for transmissions.

Per 802.11ac (Wi-Fi 5), two GI settings can be utilized such that the GI can either be set to 0.8 microseconds (μs) or 0.4 us. Per 802.11ax (Wi-Fi 6), three GI settings can be utilized such that the GI can be set to any of 0.8 μs, 1.6 μs, or 3.2 μs. Generally, longer/larger GI settings translate to lower throughput for the WLAN, as more time is spent by the wireless AP waiting between symbol transmissions. Thus, it would be advantageous to minimize the delay spread for difficult, interference inducing RF environments in order to optimize the throughput for the WLAN such that a wireless AP could utilize smaller/shorter GI settings for wireless client transmissions.

In the world of acoustic engineering, (foam) sound absorption panels are often used to dissipate the sound energy so that it is not reflected back from a hard (reflective) surface. However, in the world of RF signal propagations/reflections, it has not easily been possible to dissipate RF energy/signals. However, with the introduction of RIS technology, the individual configurable reflecting elements of an RIS panel can be used to dissipate RF energy in a manner that may be analogous to dissipation of sound energy from sound absorption panels, such that multipath interference from a highly reflective surface may be effectively eliminated within a WLAN environment.

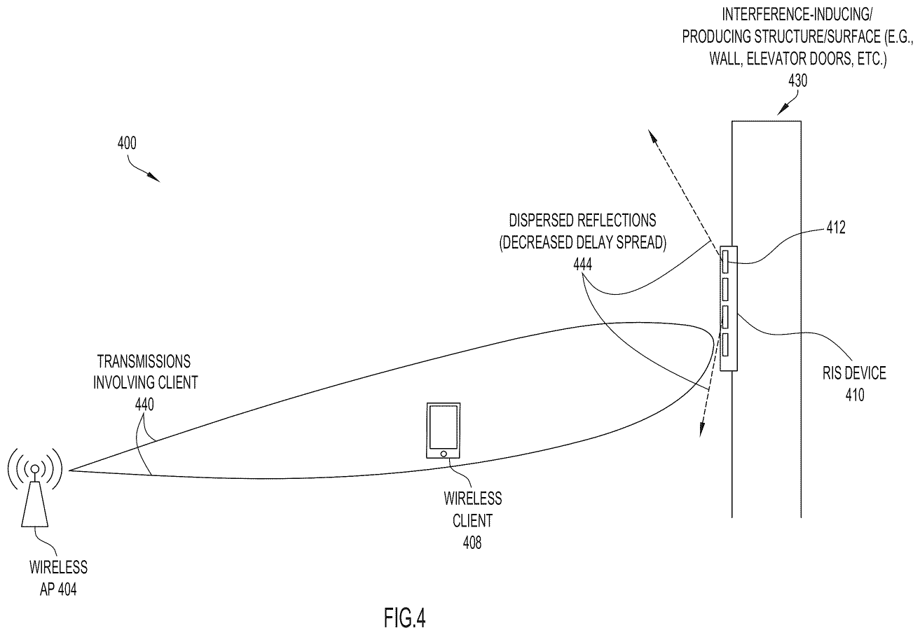

Consider, for example, FIG. 4, which is a block diagram of a system 400 associated with reducing multipath interference in a WLAN utilizing one or more RIS devices, according to an example embodiment. For example, FIG. 4 illustrates a WLAN environment in which RF problems may occur due to multipath interference that may be reflected by an interference-inducing/producing structure or surface 430 (e.g., a corridor with strong reflection components, a room corner with metallic panels, an elevator with reflective doors, etc. Also shown in FIG. 4 are a wireless AP 404, a wireless client 408, at least one RIS device 410 including configurable reflecting elements 412. Although not shown in FIG. 4, it is to be understood that a WLC can be configured for the environment in a similar manner as discussed above.

For such an environment, the RIS device 410 can be installed/mounted/affixed on or near the interference-inducing structure or surface. Although not shown in FIG. 4, it is to be understood that RIS device 410 can be configured in a similar manner as RIS device 110 as discussed above for FIG. 1 in that RIS device 410 can include configurable reflecting elements 412 and can be configured with any combination of element control logic and communication I/O (not shown in FIG. 4, but which may be configured internal or external to the RIS device 410, similar to that as discussed above for RIS device 110 of FIG. 1) to facilitate operations of RIS device 410 similar to those discussed above for RIS device 110.

Wireless AP 408 can manage/control RIS device 410 using any combination of features as discussed above with reference to FIGS. 1, 2A, 2B, and 3 in which such management/control may be performed based on RIS device 410 performing an 802.11 association with wireless AP 408 and/or may be performed using non-associated communications between the wireless AP 408 and the RIS device 410, such as PASN communications.

In contrast to the features discussed above with reference to FIGS. 1. 2A, 2B, and 3 in which wireless AP 104 seeks to manage/control RIS device 110 to optimize communications between the wireless AP 104 and a wireless client, such as wireless client 108, the management/control of RIS device 410 by wireless AP 404, or more specifically, controlling/configuring configurable reflecting elements 412 of RIS device 410 according to one or more dispersion mode configurations of the configurable reflecting elements 412 for the embodiment of FIG. 4 may be for the purpose of causing RF energy due to the interference-inducing/producing structure/surface 430 to be dissipated (e.g., in a manner analogous to acoustic dampening).

Thus, broadly during operation of the system illustrated in FIG. 4, the wireless AP 404 can be used to measure multipath interference in the WLAN environment for the RF coverage area provided wireless AP 404 and RIS device 410 (configurable reflecting elements 412 thereof), which can be placed on/near (e.g., mounted on/near, mounted to/near, affixed to/near, etc.) the interference-inducing/producing structure/surface 430, can be advantageously controlled by the wireless AP 404 to dissipate RF signal(s), effectively killing the multipath interference in the WLAN environment.

Such controlled dissipation of RF energy that can be facilitated by optimal control of an RIS device can provide for the ability to dampen or disperse reflections that would otherwise be caused by an interference-producing/inducing structure/surface, thereby reducing associated problems with such an interference-producing/inducing structure/surface, such as increased delay spread that can be caused by multipath interference. For example, dampening/dispersing reflections, can enable wireless AP 404 to lower its GI for transmissions, thereby facilitating increased or optimized throughput for the wireless AP 404 with one or more wireless client(s), such as wireless client 408

For example, during operation of the system illustrated in FIG. 4 client transmissions 440 between wireless AP 404 and wireless client 408 (which can include transmissions from wireless AP 404 to wireless client 408 and also transmissions from wireless client 408 to wireless AP 404) that otherwise may be reflected by interference-inducing structure/surface 430 thereby causing multipath interference can, in accordance with embodiments herein, by dampened/dispersed (as generally shown via dashed-line arrows 444) through management/control of the configurable reflecting elements 412 of RIS device 410 by wireless AP 404 for RF signal transmissions in order to effectively kill the multipath interference for the WLAN environment.

In at least one embodiment, management/control of RIS device 410 (and configurable reflecting elements 412) may be facilitated through one or more tuning procedures through which the wireless AP 404 examines the reflectivity in the immediate area by measuring the delay spread of transmitted signals to and from one or more target client(s) in the area, such as wireless client 408, as the RIS device 410 cycles the configurable reflecting elements 412 through a pattern or series of dispersion mode configurations, as instructed by the wireless AP prior to initiating a given tuning procedure.

After performing the tuning procedure(s), the wireless AP 404 can generate a delay spread feedback matrix, which may be similar in concept to a beam forming (sounding) feedback matrix, but focused on the (similar in concept to the beam forming feedback matrix, but focused on the standard deviation or root-mean-square (rms) value of the delay of reflections (delay spread), weighted proportional to the energy measured in reflected waves, for downlink transmissions, possibly per tone/subcarrier. For example, the delay spread feedback matrix could include, for each group of tones (e.g., by chunks of 20 Megahertz (MHz)), the delay spread mean, its standard deviation, and possibly a magnitude index (e.g., representing the magnitude of the reflected signal). Each row for the delay spread feedback matrix could indicate a tone ‘chunk’ and each column could indicate the mean, standard deviation, and magnitude for each of a corresponding configuration of the RIS device (e.g., for each of a given sounding sequence or cycle for the tuning process).

In another embodiment, the wireless AP 404 may transmit several test (management) frames one or more wireless clients, each with a different GI, and attempt to derive from the response (or lack thereof) the delay spread disturbance at the client level.

When the wireless AP 404 detects multipath interference that can cause problems in the WLAN, the wireless AP 404 can send a control signal to the RIS device 410 to adjust its individual configurable reflecting elements to attempt a dispersion pattern of the configurable reflecting elements 412 according to a particular dispersion mode configuration of the elements such that the RF dispersion pattern is intended to dissipate RF energy for wireless AP 404/wireless client 408 transmissions rather than reflect the RF energy back towards wireless AP 404.

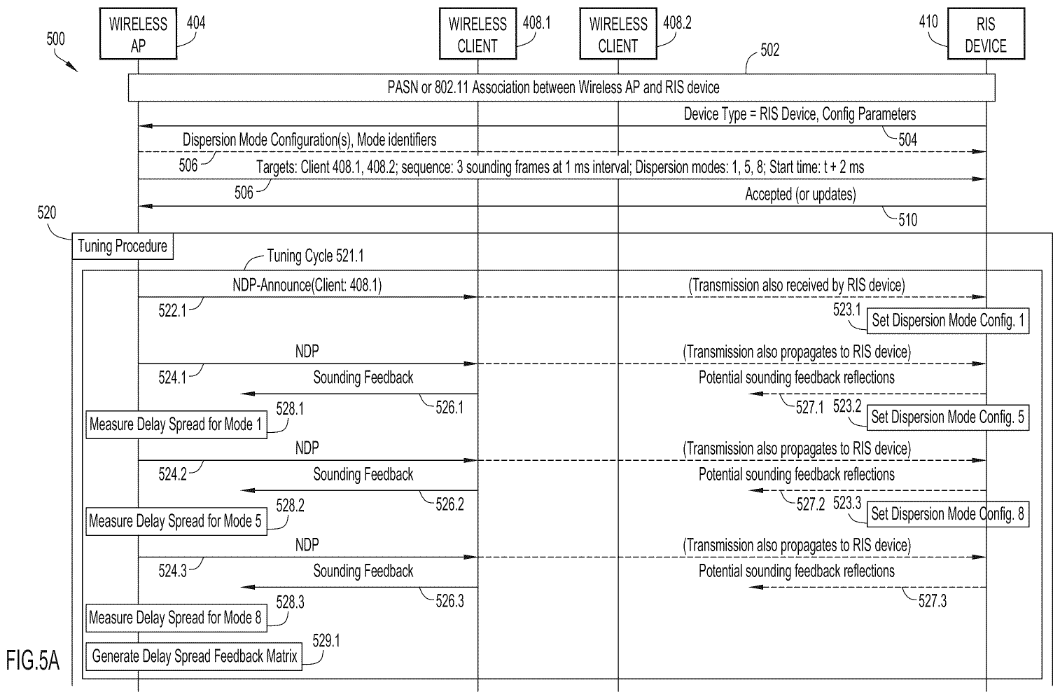

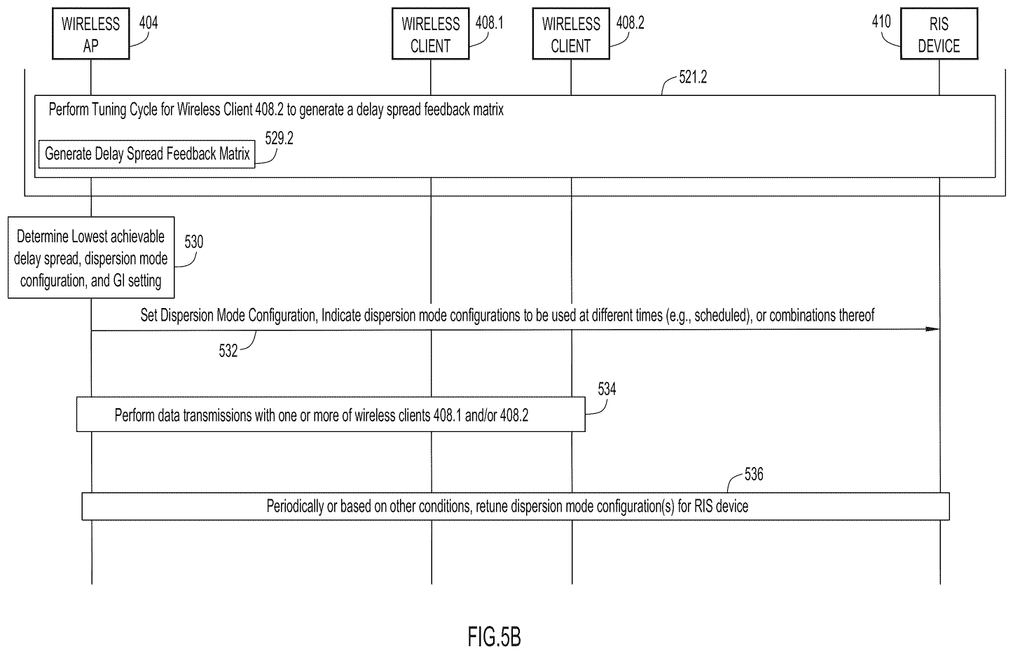

Consider an operational example, discussed with reference to FIGS. 5A and 5B, which are a message sequence diagram illustrating various operations 500 involving wireless AP 404, multiple wireless clients, such as wireless clients 408.1 and 408.2, and RIS device 410 that may be utilized to reduce multipath interference in the WLAN of FIG. 4, according to an example embodiment.

Broadly, operations 500 shown in FIGS. 5A and 5B may be associated with techniques in which RIS device 410 can be instructed to follow a set pattern of possible dispersion mode configurations of configurable reflecting elements 412 of the RIS device 410 for an RIS tuning procedure or process. As the RIS device 410 follows the instructions of the wireless AP 404 and cycles through its possible dispersion mode configurations for the RIS tuning procedure or process, the wireless AP 404 can perform transmissions with wireless client 408.1 and wireless client 408.2 and monitor/determine/measure any changes in delay spread for reflections caused in the environment. At the end of the RIS tuning procedure or process, the wireless AP 404 can determine which dispersion mode configuration of the configurable reflecting elements 412 of RIS device 410 best eliminates multipath inference for the WLAN environment for wireless clients 408.1 and 408.2 and also allows for a lowest GI setting/value to be utilized by the wireless AP 404 for transmissions involving one or both of wireless client 408.1 and/or 408.2.

Delay spread can be determined by wireless AP 404 using a variety of techniques. As noted above, delay spread is determined at the symbol level. In one embodiment, wireless AP 404 can determine delay spread/an appropriate GI setting for transmissions involving a given wireless client, say wireless client 408.1, through an indirect method using downstream/downlink traffic. In another embodiment, wireless AP can determine delay spread/an appropriate GI setting for transmissions involving the wireless client 408.1 through a direct method using upstream/uplink traffic.

For example, for the indirect method, as the wireless AP 404 is not the receiver for downlink transmissions that are to be received by the wireless client 408.1, the wireless AP 404 does not directly know how delay spread may impact the wireless client. Thus, for the indirect method of determining delay spread/an appropriate GI setting for transmissions involving the wireless client 408.1, the wireless AP 404 can rely on standards-based 802.11 operations that stipulate that the wireless client 408.1 is to send an acknowledgement (ACK) as a sign of success (or failure, if no ACK is sent from the client) for receiving a frame transmitted from wireless AP 404. If the wireless AP 404 does not receive an ACK from the wireless client 408.1 for a given transmission, then the wireless AP 404 determines a failure for the transmission, which could be for any RF reason, but when the failure occurs during RIS device 410 tuning, then the wireless AP 404 can deduce that the cause is likely due to delay spread and can tune the RIS device 410 through the tuning in order to determine a lowest GI value/setting and optimal configuration of the RIS device 410 for transmissions involving the wireless client 408.1.

For example, consider that for a given sounding frame sequence of a given tuning cycle involving a wireless client, such as wireless client 408.1, the wireless AP 404 can send a sounding frame made of consecutive symbols for a given RIS device 410 dispersion mode configuration. The wireless client 408.1 can receive the symbols and send an ACK for the frame to the wireless AP 404. Some symbols may be messed up by reflections, but each modulation is associated with a repeat value (for example, 5/6 means that 5 of every 6 symbols is new and 1 of every 6 symbols is a repeat of another symbol). In some instances, the wireless AP 404 can choose in the sounding frame a modulation that has low repeat value. Then, for a given sounding frame transmission, if the wireless client 408.1 receives the transmission, it can ACK the frame. The wireless AP 404 can then perform other sounding frame transmissions, each time with a shorter GI for the same RIS device 410 configuration, until the wireless client 408.1 stops sending an ACK, meaning that the symbols are messed up by reflections.

The wireless AP 404 can then ask/instruct the RIS device 410 to change its dispersion mode configuration and again initiate sounding with the wireless client 408.1, if the current configuration results in the frame being received by the wireless client 408.1 and sending an ACK. the wireless AP 404 can assume the dispersion mode configuration is operational for a given GI and wireless client 408.1 position. The wireless AP 404 can then try an even shorter GI and repeat the sounding frame transmissions until the wireless client 408.1 stops sending an ACK, similar to the process described above. Similar sounding frame transmissions can be performed for other dispersion mode configurations. At some point, the wireless client 408.1 may not send ACK a frame transmission from the wireless AP 404, irrespective of the RIS device 410 configuration, which can trigger the wireless AP to move back to the next highest GI setting and choose that setting as the best/shortest GI setting/value while also recording/storing the matching RIS device 410 for the corresponding configuration.

In at least one embodiment for the direct method, the wireless AP 404 can directly observe the symbols and time that the wireless AP 404 receives via uplink/upstream transmissions from the wireless client 408.1 and can determine/detect energy spikes and receive times for any (repeat) of the symbols that may also be received via reflected echoes/multipath interference created by the environment, such that delay spread between the symbols received from the wireless client 408.1 and the reflected symbols can be determined by the wireless AP 404 for different RIS device 410 configurations such that the wireless AP 404 can determine a lowest delay spread, a corresponding lowest GI setting/value, and a corresponding RIS device 410 configuration that resulted in the lowest delay spread/lowest GI setting/value. In some embodiments, the direct method of measuring delay spread could also be utilized for ACKs sent by the wireless client 408.1 (because the ACK is modulated/made of symbols) following downlink transmissions to the wireless client 408.1 sent from wireless AP 404.

The embodiment of FIGS. 5A and 5B illustrates one example embodiment involving a direct method for determining a lowest delay spread/lowest GI setting/value and a corresponding dispersion mode configuration of RIS device 410 for transmissions involving wireless clients 408.1 and 408.2; however, it is to be understood that the indirect method could also be utilized by wireless AP 404 for determining a corresponding lowest GI setting/value and a corresponding dispersion mode configuration of RIS device 410.

As illustrated at 502, the operations can include RIS device 410 communicating with wireless AP 404 via an 802.11 association of via PASN communications (as discussed above for FIG. 2A) such that, as shown at 504, the RIS device 410 can signal the nature/configuration of features provided by and/or supported by RIS device 410 to wireless AP 404. For example, the RIS device 410 can indicate (via any combination of flag(s), information element(s) (IE(s)), etc.), device type information indicating that the device is an RIS device and corresponding configuration parameters of the RIS device 410, which may include, but not be limited to, the matrix structure of configurable reflecting elements 412 (e.g., M rows by N columns), rotation angle granularity of the configurable reflecting elements 412 (e.g., π/12 radians granularity per angle change of the configurable reflecting elements), a current position of configurable reflecting elements 412, reflective capabilities of configurable reflecting elements 412 (e.g., maximum orientation, angle, or reflection), dispersion mode configurations of configurable reflecting elements 412 supported by RIS device, combinations thereof, and/or the like.

Any configuration of configurable reflecting elements 412 of RIS device 410 may be conceivable for a given dispersion mode configuration of the configurable reflecting elements 412, including static and/or dynamic configurations of the configurable reflecting elements 412 for a given dispersion mode. Consider various example dispersions mode configurations that may be facilitated for an RIS device in accordance with embodiments herein. In one example, a particular dispersion mode configuration may configure configurable reflecting elements of an RIS device to be set to a particular angle, deflecting electromagnetic energy/waves according to the particular angle. In another example, a particular dispersion mode configuration may configure configurable reflecting elements of an RIS device according to a particular row/set of rows and/or particular column/set of columns arrangement, such that some (set(s) of configurable reflecting elements may be set to a first angle, while other configurable reflecting elements may be set to a second angle (e.g., to deflect electromagnetic energy/waves directionally, up and down, left and right, or any combination thereof). In yet another example, a particular dispersion mode configuration may configure configurable reflecting elements of an RIS device to be sweep through a set pattern of angles for a particular period of time, which can include configuring set(s) of configurable reflecting elements to sweep through different patterns through the period of time. These example, dispersions mode configurations are provided for illustrative purposes only and are not meant to limit the broad scope of configurations of configurable reflecting elements of an RIS device that may be provided in accordance with embodiments herein in order to facilitate reducing multipath interference in WLAN environments.

Embodiments herein are not limited to an RIS device informing a wireless AP of its supported dispersion mode configurations, as illustrated at 504. For example, in some embodiments, based on reflecting element parameters obtained from RIS device 410 at 504, wireless AP 404 may provide or request one or more dispersion mode configurations to be supported by the RIS device 410, as shown at 506, in which the wireless AP 404 may identify particular configuration(s) of the configurable reflecting elements 412 for each of a corresponding dispersion mode configuration (e.g., specific configurations, range(s) of configurations, etc. for each of and/or sets of configurable reflecting elements 412), along with an identifier or identifying information for each dispersion mode (e.g., a mode number, mode name, etc.). In some embodiments, although not shown in FIG. 5A, RIS device 410 may confirm the dispersion mode configuration information obtained from wireless AP 404, may indicate one or requested mode(s) that may not be supported by the device, and/or may indicate updated configurations for one or more of the requested mode(s), etc.

Continuing to 508, the wireless AP 404 can transmit a sounding warning frame to the RIS device 410 that includes parameters/information for the RIS tuning procedure that is to be performed by the wireless AP 404. For the embodiment of FIGS. 5A and 5B, the RIS tuning procedure performed by the wireless AP 404 is performed for both of wireless client 408.1 and wireless client 408.2 through each of a corresponding tuning cycle in which, for each tuning cycle, the wireless AP 404 will perform a number of sounding frame transmissions for each of a corresponding dispersion mode configuration of configurable reflecting elements 412 of RIS device 410 in order to determine the delay spread of symbols contained in sounding feedback transmissions sent by a given wireless client, in which the reflections may or may not be heard/received by wireless AP 404 depending on the dispersion mode configuration of RIS device 410.

Thus, in various embodiments the parameters/information for the RIS tuning procedure included in the sounding warning frame may include, but not be limited to: sounding sequence parameters/information, such as a number of sounding frames to be transmitted by the wireless AP 404 (for each tuning cycle for each wireless client if multiple wireless clients are involved in the RIS tuning procedure); an intended interval between the sounding frame transmissions; dispersion mode configurations that are to be utilized by the RIS device 410 across the sounding frame transmissions (for each tuning cycle/wireless client, if applicable); sounding type information, timing or index information, such as a start time for the RIS tuning procedure (e.g., an absolute time or time offset relative to the time at which the sounding warning frame is received by the RIS device 410); target wireless client(s) to be involved in the RIS tuning procedure (e.g., each identified via a MAC address, IP address, etc.); a starting dispersion mode configuration for the RIS tuning procedure (or for each tuning cycle of the RIS tuning procedure, as applicable); combinations thereof; and/or the like.

For example, as shown at 508, wireless AP 404 can signal to RIS device 410, at a time ‘t’, that client devices 408.1 and 408.2 are to be involved in the RIS tuning procedure, that the RIS tuning procedure is to involve 3 sounding frames transmitted at 1 millisecond (ms) intervals for each tuning cycle, that the RIS tuning procedure is to begin at a start time of ‘t’+2 ms, and that the RIS device 410 is utilize dispersion mode configurations 1, 5, and 8 for each tuning cycle of the RIS tuning procedure. In one embodiment, the dispersion mode configurations sent to RIS device 410 can represent a set pattern of known dispersion mode configurations that are likely to be successful, as previously determined by the wireless AP 404 for the WLAN environment (e.g., through previous RIS tuning procedures, etc.). For example, depending on the type of interference-producing/inducing structure/surface 430 and geometry of the space, some different dispersion modes may work better than others.

In one embodiment, RIS device 410 may determine the dispersion mode configuration to utilize at the beginning of each tuning cycle for each wireless client involved in the RIS tuning procedure, as well as the order of utilizing the configurations, based on the order of the dispersion mode configurations sent to the RIS device 410 at 508. In another embodiment, a starting configuration and/or configuration order to utilize may be communicated separately within the parameters sent to the RIS device 410 at 508.

As shown at 510, RIS device 410 can respond to wireless AP 404 and indicate that RIS device 410 accepts the tuning parameters received from the wireless AP 404 or can indicate updates to the tuning parameters.

Thereafter, the RIS tuning procedure or process can be performed, as shown at 520, in which a first tuning cycle 521.1 is initiated for wireless client 408.1 through an NDP-A frame that is transmitted by wireless AP 404, as shown at 522.1. The NDP-A transmission is also received by RIS device 410, which triggers the RIS device 410, based on the received/agreed upon tuning parameters, to configure (via control logic for the RIS device 410) the configurable reflecting elements 412 according to dispersion mode configuration 1, as shown at 523.1.

Thereafter, a series of sounding sequences may be performed in which, for a first sounding sequence of the three sounding sequences to be performed (e.g., three sounding frames were indicated by the wireless AP 404 as being utilized for each tuning cycle of the RIS tuning procedure involving wireless clients 408.1 and 408.2), the first sounding frame for the first tuning cycle 521.1 of the RIS tuning procedure 520 is transmitted by wireless AP 404 via an NDP frame transmission (including sounding tones), as shown at 524.1. The NDP frame transmission at 524.1 also propagates to the RIS device 410 and can be reflected as discussed for the embodiment of FIGS. 2A and 2B.

As shown at 526.1. the wireless client 408.1 can transmit a sounding feedback matrix to the wireless AP for each sounding frame transmission. The sounding feedback sent by the wireless client 408.1 may also be reflected by RIS device 410 for the first dispersion mode configuration.

For any sounding feedback reflections that may be received by the wireless AP 404, the wireless AP 404 can measure, as shown at 528.1, the delay spread between symbols contained in the sounding feedback sent by the wireless client 408.1 and corresponding symbols of the feedback that may also be received via any reflections.

As the sounding feedback transmitted by the wireless client at 526.1 includes identifying information (e.g., MAC address) for the wireless client 408.1, in at least one embodiment, RIS device 410, via communications I/O configured for the RIS device (which is configured to operate in accordance with 802.11 standards, as discussed herein) can identify/detect that the first sounding feedback transmission from wireless client 408.1 has been transmitted and can update the configuration of configurable reflecting elements 412 to be set to correspond to dispersion mode configuration 5, as shown at 523.2, potentially after some delta period of time based on when the first sounding feedback transmission from wireless client 408.1 was detected by the RIS device 410 and the RIS tuning procedure parameters indicating the sounding frame intervals for the RIS tuning procedure, (e.g., updating the configuration after 200 microseconds (μs) of receiving the NDP frame transmission, based on 1 ms intervals for sounding frame transmissions). In another embodiment, RIS device 410 may not detect the sounding feedback transmission being sent from wireless client 408.1, but rather may update the dispersion mode configuration for the configurable reflecting elements merely after waiting a period of time, based on the start time of the RIS tuning procedure and the sounding frame interval information via the tuning parameters that were provided to RIS device 410 from the wireless AP 404 at 508.

Thereafter, the next two sounding sequences for the first tuning cycle 521.1 can be performed in a similar manner, as shown at 524.2, 526.2, 527.2 (for potential reflections), and 528.2 (measuring delay spread), and also at 523.3 for updating the configurable reflecting elements to be set to dispersion mode configuration 8 following the second sounding frame transmission for the subsequent sounding frame transmission sequence as illustrated at 524.3, 526.3, 527.3, and 528.3.

Following the transmission of the last sounding frame for the tuning cycle and determining the delay spread for any sounding feedback reflections, the wireless AP 404 can generate a delay spread feedback matrix indicating delay spread associated with wireless client 408.1 transmissions, as shown at 529.1.

For an embodiment in which delay spread is to be measured for only one wireless client, such as wireless client 408.1, the operations illustrated in FIGS. 5A and 5B may continue such that the wireless AP 404 can identify, based on the delay spread feedback matrix, a lowest measured delay spread for multipath interference that may be attainable for the WLAN environment and a corresponding lowest GI setting based on the determined lowest measured delay spread and can also identify a corresponding dispersion mode configuration of the RIS device 410 that provided the lowest measured delay spread. In one embodiment, wireless AP 404 may be configured with GI settings/values that may be utilized for corresponding measured delay spreads such that, upon determining a lowest measured delay spread, the wireless AP 404 can identify a corresponding GI setting to be utilized for transmissions involving wireless client 408.1 (e.g., the GI time that the wireless AP 404 is to wait between symbol transmissions involving the wireless client 408.1). Thereafter, for subsequent data transmissions that are to involve the wireless client 408.1, the wireless AP 404 can instruct the RIS device 410 to set the configurable reflecting elements to a corresponding dispersion mode configuration for the data transmissions and the wireless AP 404 can set a GI setting/value for the transmissions based on the lowest measured delay spread.

However, for the embodiment of FIGS. 5A and 5B involving multiple wireless clients 408.1 and 408.2, wireless AP 404 performs a second tuning cycle 521.2 for the RIS tuning procedure 520 that involves wireless client 408.2, as shown in FIG. 5B. The second tuning cycle 521.2 is performed in a similar manner as the first tuning cycle 521.1, such that the wireless AP 404 can generate a delay spread feedback matrix indicating delay spread associated with wireless client 408.2 transmissions, as shown at 529.2.

Following the RIS tuning procedure, the wireless AP 404 can determine a lowest achievable delay spread for the wireless clients 408.1 and 408.2, a corresponding dispersion mode configuration of the RIS device 410 responsible for the lowest achievable delay spread, and a GI setting that can be utilized for transmissions involving wireless clients 408.1 and 408.2 based on the lowest achievable delay spread, as shown at 530. Thus, when the lowest achievable multipath interference (the lowest delay spread) is determined/converged upon for the environment, the wireless AP 404 automatically sets its GI to an optimal level/setting.

For WLAN environments in which multiple wireless clients can be impacted by the effects of multipath interference (e.g., increased GI settings/lowered WLAN throughput), there are likely a subset of RIS reflecting element positions that may be utilized to maximize the overall benefit to all wireless clients. Thus, as shown at 532, in various embodiments, dispersion mode configuration(s) of the RIS device 410 can be tailored (and adjusted by the wireless AP 404) for transmissions involving different clients (e.g., potentially instructing the RIS device 410 to adjust dispersion mode configurations of the configurable reflecting elements 412 according to a schedule for transmissions involving the different wireless clients), can be adjusted to facilitate a maximized dispersion of multipath interference for the WLAN environment (e.g., a dispersion that minimizes the effect of multipath interference for a target set or group of wireless clients, potentially different groups of clients at different times), or combinations thereof. Thereafter, the wireless AP 404 can perform data transmissions with one or more of wireless clients 408.1 and/or 408.2, as shown at 534.

The wireless AP 404 can, periodically or based on other conditions (e.g., movement of wireless clients, detection of increased delay spread, etc.), retune the dispersion mode configuration(s) of the RIS device, as shown at 536.

Although FIGS. 5A and 5B illustrate operations involving only one wireless AP, in some embodiments, multiple wireless APs can work together as a coordinated group to minimize multipath interference in a WLAN environment. For example, in at least one embodiment, multiple wireless APs that are in the vicinity of each other (e.g., able to receive each other's communications), can report their delay spread measurements and/or GI setting (e.g., to each other and/or to a WLC) and how changes in RIS dispersion mode configurations of one or more RIS devices in the environment may affect their measured delay spread and/or GI setting, such that the multiple wireless APs can agree to an optimal dispersion mode configuration of the RIS device(s) and set their individual GIs based on the collectively observed delay spread measurements and/or GI settings. In another embodiment, listener devices in an environment (e.g., non-transmitting wireless APs, scanning APs, etc.) may be used to monitor changes in delay spread (multipath interference) and report this back to wireless AP(s) that may be controlling one or more RIS device(s).

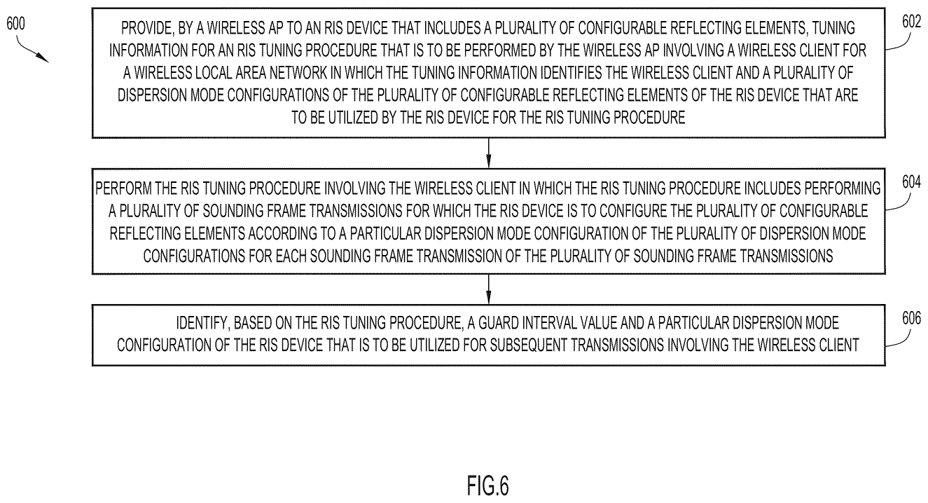

Referring to FIG. 6, FIG. 6 is a flow chart depicting a method 600 according to an example embodiment. In at least one embodiment, method 600 may be associated with operations that may be utilized to reduce multipath interference in a WLAN, which may be performed by at least in part by a wireless AP, such as wireless AP 404, and/or by an RIS device, such as RIS device 410, as illustrated in FIG. 4.

At 602, the method may include providing, by a wireless AP to an RIS device that includes a plurality of configurable reflecting elements, tuning information for an RIS tuning procedure that is to be performed by the wireless AP involving a wireless client for a wireless local area network (provided via the wireless AP) in which the tuning information identifies the wireless client and a plurality of dispersion mode configurations of the plurality of configurable reflecting elements of the RIS device that are to be utilized by the RIS device for the RIS tuning procedure. In one embodiment, the tuning information further identifies a number of sounding frame transmissions that are to be utilized for the RIS tuning procedure involving the client, a sounding frame transmission interval, and start time information for the RIS tuning procedure. In one embodiment, the tuning information further identifies at least one a dispersion mode configuration that is to be utilized at a start of the RIS tuning procedure and an order of the dispersion mode configurations that are to be utilized for the RIS tuning procedure. In one embodiment, the tuning information can be provided to the RIS device via a sounding warning frame transmitted by the wireless AP.

In some embodiments, prior to the operations at 602, the method may include obtaining, by the wireless AP from the RIS device, configuration parameters or information identifying feature(s) provided and/or supported by the RIS device, such as device type information indicating that the device is an RIS device and corresponding configuration parameters of the RIS device, which may include, but not be limited to, a matrix structure or any other structure of configurable reflecting elements (e.g., M rows by N columns or some other configuration), rotation angle granularity of the configurable reflecting elements (e.g., π/12 radians granularity per angle change of the configurable reflecting elements), a current position of configurable reflecting elements, reflective capabilities of configurable reflecting elements (e.g., maximum orientation, angle, or reflection), dispersion mode configurations of configurable reflecting elements supported by RIS device, combinations thereof, and/or the like. In some embodiments, the configuration parameters/information can be sent to the wireless AP without the RIS device performing an 802.11 association with the wireless AP. For example, in some embodiments, the RIS device can send the configuration parameters/information via PASN communications with the wireless AP.

At 604, the method may include the wireless AP performing the RIS tuning procedure involving the wireless client in which the RIS tuning procedure includes performing a plurality of sounding frame transmissions for which the RIS device is to configure the plurality of configurable reflecting elements according to a particular dispersion mode configuration of the plurality of dispersion mode configurations for each sounding frame transmission of the plurality of sounding frame transmissions.

In one embodiment, the RIS device may determine that a particular sounding frame transmission sequence has completed based on detecting sounding feedback being transmitted by the wireless client for a given sounding frame transmission, such that the RIS device can update the dispersion mode configuration of the configurable reflecting elements prior to a subsequent sounding frame transmission being performed by the wireless AP. In one embodiment, the RIS device may update the dispersion mode configuration of the configurable reflecting elements prior to a subsequent sounding frame transmission being performed by the wireless AP based on sounding frame transmission interval and tuning procedure start time information obtained from the wireless AP.

At 606, the method may include identifying, based on the RIS tuning procedure, a guard interval value and a particular dispersion mode configuration of the RIS device that is to be utilized for subsequent transmissions involving the wireless client.

In some embodiments, the guard interval value may be identified utilizing the direct method of determining delay spread based on wireless AP measuring delay spread for (symbol) reflections for sounding feedback sent from the wireless client for each sounding frame transmission of the plurality of sounding frame transmissions sent from the wireless AP. The wireless AP can determine a lowest measured delay spread through the RIS tuning procedure and can identify the guard interval value to be utilized based on the lowest measured delay spread, along with the particular dispersion mode configuration of the RIS device to utilize for data transmissions involving the wireless client. In some embodiments, the guard interval value may be identified utilizing an RIS tuning procedure that involves the indirect method in which iterative frame transmissions and wireless client ACKs (or failure thereof) can be used to identify the guard interval value along with the particular dispersion mode configuration of the RIS device to utilize for data transmissions involving the wireless client.

Although not shown in FIG. 6, the method may further include instructing the RIS device to implement the particular dispersion mode configuration prior to the wireless AP performing the subsequent transmissions involving the wireless client.

Operations for the method discussed for FIG. 6 involving multiple wireless clients can include multiple RIS tuning cycles for the tuning procedure, as discussed above for FIGS. 5A and 5B, in which, for each RIS tuning cycle of the plurality of RIS tuning cycles, the wireless AP performs a plurality of sounding frame transmissions in which the RIS device is to configure the plurality of configurable reflecting elements according to a corresponding dispersion mode configuration of the plurality of dispersion mode configurations for each sounding frame transmission of the plurality of sounding frame transmissions. For such instances involving multiple wireless clients, the method may further include identifying a particular guard interval value and a particular corresponding dispersion mode configuration of the RIS device that is to be utilized for transmissions involving any of the plurality of wireless clients. Further, the method may include instructing the RIS device to implement the particular corresponding dispersion mode configuration for the transmissions involving any wireless client of the plurality of wireless clients.

Accordingly, embodiments herein may provide for the ability to reduce multipath interference in a WLAN environment utilizing one or more RIS devices, thereby increasing or optimizing throughput provided by one or more wireless APs for one or more wireless clients within the WLAN environment.

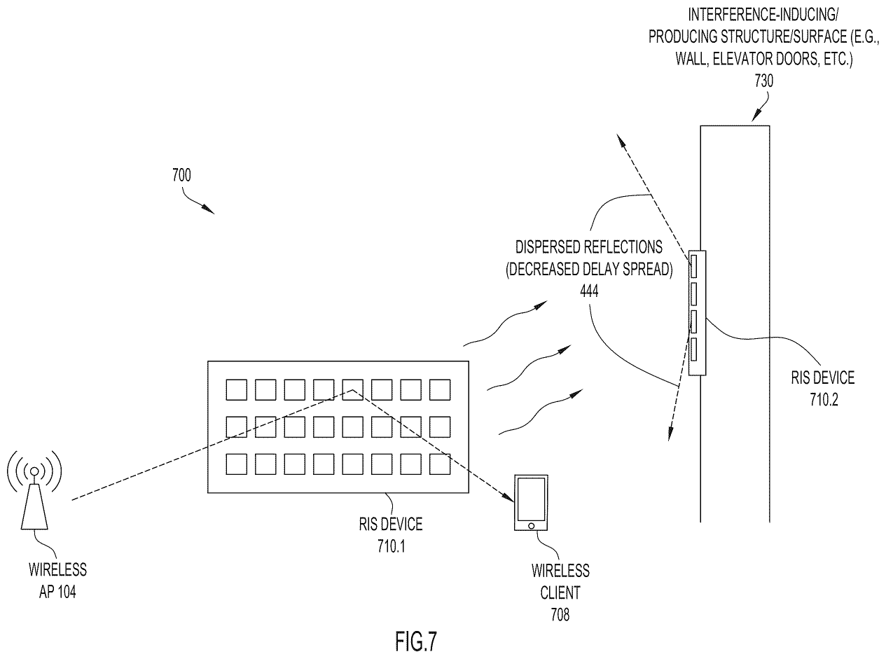

Referring to FIG. 7, FIG. 7 is a block diagram illustrating features of a system 700 that may be utilized to facilitate coordinated steering of an RIS device and reducing multipath interference in a WLAN utilizing another RIS device, according to an example embodiment. FIG. 7 illustrates a WLAN environment that includes a wireless AP 704, a wireless client 708, a first RIS device 710.1 (including configurable reflecting elements, not labeled in FIG. 7) and a second RIS device 710.2 (including configurable reflecting elements, not labeled in FIG. 7). Although not shown in FIG. 7, it is to be understood that a WLC can be configured for the environment in a similar manner as discussed above. As shown in FIG. 7, second RIS device 710.1 can be installed/mounted/affixed on or to an interference-inducing/producing structure/surface 730 in the WLAN environment.

Generally, the embodiment of FIG. 7 involving system 700 may represent a combination of system 100 of FIG. 1 and of system 400 of FIG. 4, which illustrates that any combination of RIS devices may be utilized in a WLAN environment to facilitate both coordinated steering of RIS device 710.1 by wireless AP 704 in order to facilitate to optimized transmissions between the wireless AP 704 and wireless client 708 and also facilitate reduced multipath interference in the WLAN environment that may be caused by interference-inducing/producing structure/surface 730 by optimally controlling dispersion mode configuration(s) of RIS device 710.1 by wireless AP 704 to effectively disperse/kill multipath interference (minimize delay spread) for the WLAN environment such that a minimum GI value can be utilized by wireless AP 704 for transmissions to wireless client 708.

Thus, it is to be understood that each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

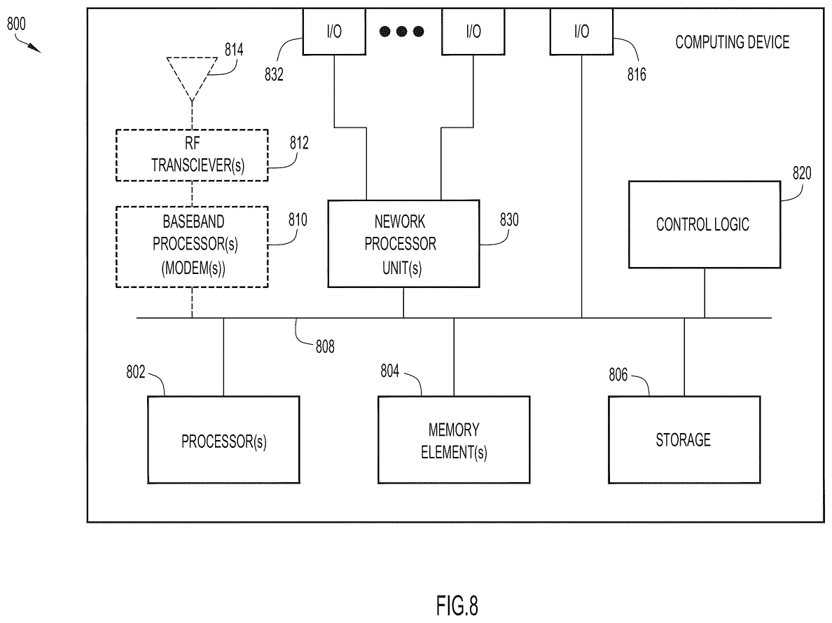

Referring to FIG. 8, FIG. 8 illustrates a hardware block diagram of a computing device 800 that may perform functions associated with operations discussed herein. In various embodiments, a computing device or apparatus, such as computing device 800 or any combination of computing devices 800, may be configured as any entity/entities as discussed herein, such as a wireless AP (e.g., any of wireless AP 104, 404, and/or 704), an RIS device (e.g., any of RIS device 110, 410, 710.1, and/or 710.2), a WLC (e.g., WLC 102), a wireless client (e.g., any of wireless client 108, etc.) and/or any other element, controller, communication element, and/or the like discussed herein in order to perform operations of the various techniques/embodiments discussed herein.

In at least one embodiment, computing device 800 may be any apparatus that may include one or more processor(s) 802, one or more memory element(s) 804, storage 806, a bus 808, one or more I/O interface(s) 816, control logic 820 (e.g., element control logic or RIS control logic as discussed herein), one or more one network processor unit(s) 830 and one or more network I/O interface(s) 832. In various embodiments, instructions associated with logic for computing device 800 can overlap in any manner and are not limited to the specific allocation of instructions and/or operations described herein.

For embodiments in which computing device 800 may be implemented as any device capable of wireless communications, computing device 800 may further include at least one baseband processor or modem 810, one or more radio RF transceiver(s) 812 (e.g., any combination of RF receiver(s) and RF transmitter(s)), one or more antenna(s) or antenna array(s) 814.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, graphical processing units (GPUs), microprocessors, digital signal processor, baseband signal processor, modem, physical layer (PHY), computing devices, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa) or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that are configured for computing device 800. In at least one embodiment, bus 808 is implemented as a fast kernel-hosted interconnect, potentially using shared memory between processes (e.g., logic), which can enable efficient communication paths between the processes.

Network processor unit(s) 830 may enable communication between computing device 800 and other systems, devices, or entities, via network I/O interface(s) 832 (wired and/or wireless) to facilitate operations discussed for various embodiments described herein. In various embodiments, network processor unit(s) 830 can be configured as a combination of hardware and/or software, such as one or more Ethernet driver(s) and/or computing device(s) or interface cards, Fibre Channel (e.g., optical) driver(s) and/or computing device(s), wireless receivers/transmitters/transceivers, baseband processor(s)/modem(s), and/or other similar network interface driver(s) and/or computing device(s) now known or hereafter developed to enable communications between computing device 800 and other systems, devices, or entities to facilitate operations for various embodiments described herein. In various embodiments, network I/O interface(s) 832 can be configured as one or more Ethernet port(s), Fibre Channel ports, any other I/O port(s), and/or antenna(s)/antenna array(s) now known or hereafter developed. Thus, the network processor unit(s) 830 and/or network I/O interface(s) 832 may include suitable interfaces for receiving, transmitting, and/or otherwise communicating data and/or information (wired and/or wirelessly) in a network environment.

I/O interface(s) 816 allow for input and output of data and/or information with other entities that are connected to computing device 800. For example, I/O interface(s) 816 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen. In some embodiments, the computing device 800 supports a display having touch-screen display capabilities.

For embodiments in which computing device 800 is implemented as a wireless device or any apparatus capable of wireless communications, the RF transceiver(s) 812 may perform RF transmission and RF reception of wireless signals via antenna(s)/antenna array(s) 814, and the baseband processor or modem 810 performs baseband modulation and demodulation, etc. associated with such signals to enable wireless communications for computing device 800.

In various embodiments, control logic 820 (which can include any combination of RIS management logic for a wireless AP, element control logic for an RIS device, etc.) can include instructions that, when executed, cause processor(s) 802 to perform operations, which can include, but not be limited to, providing overall control operations of computing device 800; interacting with other entities, elements, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820 of computing device 800) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database. table, and register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) (e.g., memory element(s) 804 of computing device 800) and/or storage (e.g., storage 806 of computing device 800) can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include providing. by a wireless access point (AP) to a Reconfigurable Intelligent Surface (RIS) device that includes a plurality of configurable reflecting elements, tuning information for an RIS tuning procedure that is to be performed by the wireless AP involving a wireless client for a wireless local area network, wherein the tuning information identifies the wireless client and a plurality of dispersion mode configurations of the plurality of configurable reflecting elements of the RIS device that are to be utilized by the RIS device for the tuning procedure; performing the RIS tuning procedure involving the wireless client, wherein the RIS tuning procedure comprises performing a plurality of sounding frame transmissions in which the RIS device is to configure the plurality of configurable reflecting elements according to a particular dispersion mode configuration of the plurality of dispersion mode configurations for each sounding frame transmission of the plurality of sounding frame transmissions; and identifying, based on the RIS tuning procedure, a guard interval value and a particular dispersion mode configuration of the RIS device that is to be utilized for subsequent transmissions involving the wireless client.

The method may further include instructing the RIS device to provide the particular dispersion mode configuration prior to the wireless AP performing the subsequent transmissions involving the wireless client in which the particular dispersion mode configuration facilitates dispersing multipath interference by the RIS device for the subsequent transmissions involving the wireless client.

In one instance, the tuning information further identifies a number of sounding frame transmissions that are to be utilized for the RIS tuning procedure, a sounding frame transmission interval, and start time information for the RIS tuning procedure.

In one instance, the method may further include providing, by the wireless AP, dispersion mode configuration information to the RIS device that identifies a configuration of the plurality of configurable reflecting elements for each dispersion mode configuration of the plurality of dispersion mode configurations and identifies a particular dispersion mode identifier for each dispersion mode of the plurality of dispersion mode configurations.

In one instance, the method may further include obtaining, by the wireless AP, one of: a confirmation from the RIS device that the RIS device has accepted the tuning information as provided by the wireless AP; or updated tuning information from the RIS device for the RIS tuning procedure.

In one instance, the RIS tuning procedure is performed for a plurality of wireless clients in which the RIS tuning procedure comprises a plurality of RIS tuning cycles in which, for each tuning cycle of the plurality of tuning cycles, the wireless AP performs a plurality of sounding frame transmissions in which the RIS device is to configure the plurality of configurable reflecting elements according to a corresponding dispersion mode configuration of the plurality of dispersion mode configurations for each sounding frame transmission of the plurality of sounding frame transmissions. In one instance, the method may further include identifying a particular guard interval value and a particular corresponding dispersion mode configuration of the RIS device that is to be utilized for transmissions involving any wireless client of the plurality of wireless clients.

In one instance, the method may further include instructing the RIS device to implement the particular corresponding dispersion mode configuration for the transmissions involving any wireless client of the plurality of wireless clients.

In one instance, the RIS device is mounted on or near an interference producing structure or surface within coverage area of the wireless local area network provided by the wireless AP.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, and/or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the ’(s)' nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
providing, by a wireless access point (AP) to a Reconfigurable Intelligent Surface (RIS) device that includes a plurality of configurable reflecting elements, tuning information for an RIS tuning procedure that is to be performed by the wireless AP involving a wireless client for a wireless local area network, wherein the tuning information identifies the wireless client and a plurality of dispersion mode configurations of the plurality of configurable reflecting elements of the RIS device that are to be utilized by the RIS device for the RIS tuning procedure;
performing the RIS tuning procedure involving the wireless client, wherein the RIS tuning procedure comprises performing a plurality of sounding frame transmissions in which the RIS device is to configure the plurality of configurable reflecting elements according to a particular dispersion mode configuration of the plurality of dispersion mode configurations for each sounding frame transmission of the plurality of sounding frame transmissions; and
identifying, based on the RIS tuning procedure, a guard interval value and a particular dispersion mode configuration of the RIS device that is to be utilized for subsequent transmissions involving the wireless client.

2. The method of claim 1, further comprising:
instructing the RIS device to provide the particular dispersion mode configuration prior to the wireless AP performing the subsequent transmissions involving the wireless client.

3. The method of claim 2, wherein the particular dispersion mode configuration facilitates dispersing multipath interference by the RIS device for the subsequent transmissions involving the wireless client.

4. The method of claim 1, wherein the tuning information further identifies a number of sounding frame transmissions that are to be utilized for the RIS tuning procedure, a sounding frame transmission interval, and start time information for the RIS tuning procedure.

5. The method of claim 1, further comprising:
providing, by the wireless AP, dispersion mode configuration information to the RIS device that identifies a configuration of the plurality of configurable reflecting elements for each dispersion mode configuration of the plurality of dispersion mode configurations and identifies a particular dispersion mode identifier for each dispersion mode of the plurality of dispersion mode configurations.

6. The method of claim 1, further comprising:
obtaining, by the wireless AP, one of:
a confirmation from the RIS device that the RIS device has accepted the tuning information as provided by the wireless AP; or
updated tuning information from the RIS device for the RIS tuning procedure.

7. The method of claim 1, wherein the RIS tuning procedure is performed for a plurality of wireless clients in which the RIS tuning procedure comprises a plurality of RIS tuning cycles in which, for each tuning cycle of the plurality of tuning cycles, the wireless AP performs a plurality of sounding frame transmissions in which the RIS device is to configure the plurality of configurable reflecting elements according to a corresponding dispersion mode configuration of the plurality of dispersion mode configurations for each sounding frame transmission of the plurality of sounding frame transmissions.

8. The method of claim 7, further comprising:
identifying a particular guard interval value and a particular corresponding dispersion mode configuration of the RIS device that is to be utilized for transmissions involving any wireless client of the plurality of wireless clients.

9. The method of claim 8, further comprising:
instructing the RIS device to implement the particular corresponding dispersion mode configuration for the transmissions involving any wireless client of the plurality of wireless clients.

10. The method of claim 1, wherein the RIS device is mounted on or near an interference producing structure or surface within coverage area of the wireless local area network provided by the wireless AP.

11. One or more non-transitory computer readable storage media encoded with instructions that, when executed by a processor, cause the processor to perform operations, comprising:
providing, by a wireless access point (AP) to a Reconfigurable Intelligent Surface (RIS) device that includes a plurality of configurable reflecting elements, tuning information for an RIS tuning procedure that is to be performed by the wireless AP involving a wireless client for a wireless local area network, wherein the tuning information identifies the wireless client and a plurality of dispersion mode configurations of the plurality of configurable reflecting elements of the RIS device that are to be utilized by the RIS device for the RIS tuning procedure;
performing the RIS tuning procedure involving the wireless client, wherein the RIS tuning procedure comprises performing a plurality of sounding frame transmissions in which the RIS device is to configure the plurality of configurable reflecting elements according to a particular dispersion mode configuration of the plurality of dispersion mode configurations for each sounding frame transmission of the plurality of sounding frame transmissions; and
identifying, based on the RIS tuning procedure, a guard interval value and a particular dispersion mode configuration of the RIS device that is to be utilized for subsequent transmissions involving the wireless client.

12. The media of claim 11, wherein the instructions, when executed by the processor, cause the processor to perform further operations, comprising:
instructing the RIS device to provide the particular dispersion mode configuration prior to the wireless AP performing the subsequent transmissions involving the wireless client.

13. The media of claim 11, wherein the tuning information further identifies a number of sounding frame transmissions that are to be utilized for the RIS tuning procedure, a sounding frame transmission interval, and start time information for the RIS tuning procedure.

14. The media of claim 11, wherein the instructions, when executed by the processor, cause the processor to perform further operations, comprising:
providing, by the wireless AP, dispersion mode configuration information to the RIS device that identifies a configuration of the plurality of configurable reflecting elements for each dispersion mode configuration of the plurality of dispersion mode configurations and identifies a particular dispersion mode identifier for each dispersion mode of the plurality of dispersion mode configurations.

15. The media of claim 11, wherein the RIS tuning procedure is performed for a plurality of wireless clients in which the RIS tuning procedure comprises a plurality of RIS tuning cycles in which, for each tuning cycle of the plurality of tuning cycles, the wireless AP performs a plurality of sounding frame transmissions in which the RIS device is to configure the plurality of configurable reflecting elements according to a corresponding dispersion mode configuration of the plurality of dispersion mode configurations for each sounding frame transmission of the plurality of sounding frame transmissions.

16. A system comprising:
at least one memory element for storing data; and
at least one processor for executing instructions associated with the data, wherein executing the instructions causes the system to perform operations, comprising:
providing, by a wireless access point (AP) to a Reconfigurable Intelligent Surface (RIS) device that includes a plurality of configurable reflecting elements, tuning information for an RIS tuning procedure that is to be performed by the wireless AP involving a wireless client for a wireless local area network, wherein the tuning information identifies the wireless client and a plurality of dispersion mode configurations of the plurality of configurable reflecting elements of the RIS device that are to be utilized by the RIS device for the RIS tuning procedure;
performing the RIS tuning procedure involving the wireless client, wherein the RIS tuning procedure comprises performing a plurality of sounding frame transmissions in which the RIS device is to configure the plurality of configurable reflecting elements according to a particular dispersion mode configuration of the plurality of dispersion mode configurations for each sounding frame transmission of the plurality of sounding frame transmissions; and
identifying, based on the RIS tuning procedure, a guard interval value and a particular dispersion mode configuration of the RIS device that is to be utilized for subsequent transmissions involving the wireless client.

17. The system of claim 16, wherein executing the instructions causes the system to perform further operations, comprising:
instructing the RIS device to provide the particular dispersion mode configuration prior to the wireless AP performing the subsequent transmissions involving the wireless client.

18. The system of claim 16, wherein the tuning information further identifies a number of sounding frame transmissions that are to be utilized for the RIS tuning procedure, a sounding frame transmission interval, and start time information for the RIS tuning procedure.

19. The system of claim 16, wherein executing the instructions causes the system to perform further operations, comprising:
providing, by the wireless AP, dispersion mode configuration information to the RIS device that identifies a configuration of the plurality of configurable reflecting elements for each dispersion mode configuration of the plurality of dispersion mode configurations and identifies a particular dispersion mode identifier for each dispersion mode of the plurality of dispersion mode configurations.

20. The system of claim 16, wherein the RIS tuning procedure is performed for a plurality of wireless clients in which the RIS tuning procedure comprises a plurality of RIS tuning cycles in which, for each tuning cycle of the plurality of tuning cycles, the wireless AP performs a plurality of sounding frame transmissions in which the RIS device is to configure the plurality of configurable reflecting elements according to a corresponding dispersion mode configuration of the plurality of dispersion mode configurations for each sounding frame transmission of the plurality of sounding frame transmissions.
